(19) United States
(12) Patent Application Publication
(10) Pub. No.: US 2017/0362883 A1
(43) Pub. Date: Dec. 21, 2017

(54) DAYLIGHTING DEVICE

(71) Applicant: Sharp Kabushiki Kaisha, Sakai City, Osaka (JP)

(72) Inventors: TORU KANNO, Sakai City (JP); TSUYOSHI KAMADA, Sakai City (JP); SHUN UEKI, Sakai City (JP); SHUMPEI NISHINAKA, Sakai City (JP); HIDEOMI YUI, Sakai City (JP); DAiSUKE SHINOZAK!, Sakai City (JP); TOMOKO UEK!, Sakai City (JP)

(73) Assignee: Sharp Kabushiki Kaisha, Sakai-City, Osaka (JP)

(21) Appl. No.: 15/532,373

(22) PCT Filed: Dec. 3, 2015
(86) PCT No.: PCT/JP2015/083973

§ 371 Date: Jun. 1, 2017

(30) Foreign Application Priority Data
Dec. 4, 2014 (JP) 2014-245745

(51) Int. Cl. E06B 3/67; E06B 7/08; E06B 7/10; F21V 31/03; F21S 11/00; E06B 7/02

(52) U.S. Cl. CPC E06B 3/67; F21V 31/03; F21S 11/007; E06B 7/08; E06B 7/10; E06B 2007/023

(57) ABSTRACT

A daylighting device of the present invention includes: a daylighting member including: a first light-transmitting base member; and a plurality of protruding, light-transmitting daylighting sections provided on a first face or a second face of the first light-transmitting base member; and a ventilation hole configured to enable a space on the first face to communicate with a space on the second face opposite from the first face.

### TECHNICAL FIELD

The present invention relates to daylighting devices. The present application claims priority to Japanese Patent Application, Tokugan, No. 2014-245745 filed in Japan on Dec. 4, 2014, the entire contents of which are incorporated herein by reference.

### BACKGROUND ART

Daylighting films have been proposed for admitting sunlight into a building's interior, for example, through windows of the building. A typical daylighting film includes a light-transmitting support having formed on one of the faces thereof a plurality of unit prisms and a flat face. Sunlight is admitted into the interior through the unit prisms. One can guide external light into the interior to provide a brightly lit space, by attaching such a daylighting film to window glass.

However, if a special daylighting film is attached to a window, there may occur thermal cracking of the window glass. In view of this, Patent Literature 1 describes an insolation adjusting method in which rolling screen sheet materials (daylighting device) having insolation blocking properties are disposed at a distance from the indoor-side glass surface of wire-reinforced window glass.

### CITATION LIST

### Patent Literature

Patent Literature 1

Japanese Unexamined Patent Application Publication, Tokukai, No. 2012-207444

### SUMMARY OF INVENTION

### Technical Problem

According to a description in Patent Literature 1, the thermal cracking of the window glass can be suppressed by disposing the daylighting device at a distance from the window glass. However, it is still difficult to completely prevent thermal cracking of glass because of the difference in thermal expansion coefficient between the metal wires and glass. Additionally, in multilayered-glass daylighting devices having a hollow structure providing high thermal insulation, daylighting devices with low thermal conductivity, and other like daylighting devices, there is a chance of air being heated by sunlight irradiation and collecting between the window glass and the daylighting device. In these daylighting devices, it is not only the window glass, but also a substrate in the daylighting device, that may crack under heat.

An aspect of the present invention has been conceived in view of the abovementioned conventional problems and has an object to provide a daylighting device capable of preventing thermal cracking of window glass and a substrate in the daylighting device by suppressing temperature increases between the window glass and the daylighting device.

### Solution to Problem

In one aspect, the present invention is directed to a daylighting device including: a daylighting member including: a first base member having light-transmitting properties; and a plurality of protruding daylighting sections having light-transmitting properties and provided on a first face or a second face of the first base member; and a ventilation hole configured to enable a space on the first face to communicate with a space on the second face opposite from the first face.

In another aspect of the present invention, the daylighting device may be configured so that the first through hole is provided in a region where the daylighting member makes no contribution to daylighting.

In yet another aspect of the present invention, the daylighting device may be configured so that: the daylighting member has a first through hole extending through a thickness direction of the daylighting member; and the ventilation hole includes the first through hole.

In still another aspect of the present invention, the daylighting device may be configured to further include a light-diffusion member provided on either a light-entering side or a light-exiting side of the daylighting member, wherein: the ventilation hole includes the first through hole and a second through hole extending through a thickness direction of the light-diffusion member; and the second through hole at least partially overlaps the first through hole when viewed normal to the daylighting member.

In yet still another aspect of the present invention, the daylighting device may be configured so that: the light-diffusion member is provided on the light-exiting side of the daylighting member; and the second through hole is smaller in size than the first through hole.

In a further aspect of the present invention, the daylighting device may be configured so that: the second through hole has such a shape that has a lengthwise direction; and the second through hole resides so that the lengthwise direction thereof is parallel to an extension direction of the daylighting sections.

In yet a further aspect of the present invention, the daylighting device may be configured so that: the light-diffusion member includes an adhesive layer having such anisotropy in light-diffusion properties as to diffuse more light in a direction that intersects the two disposition directions than in the two disposition directions; and the daylighting member is provided on a transparent base member with the light-diffusion member interposed therebetween.

In still a further aspect of the present invention, the daylighting device may be configured so that the ventilation hole forms a single communication hole by including the daylighting member, the light-diffusion member, and an affixing member provided between the daylighting member and the light-diffusion member disposed at a distance from each other.

In yet still a further aspect of the present invention, the daylighting device may be configured so that the ventilation hole is provided in a region through which not much sunlight enters the daylighting member.

In an additional aspect of the present invention, the daylighting device may be configured so that the ventilation hole has an inner face on which there is provided a material having light-blocking properties.

In another aspect of the present invention, the daylighting device may be configured to include a frame containing at least the daylighting member, wherein the ventilation hole is provided between the daylighting member and the frame.

In yet another aspect of the present invention, the daylighting device may be configured to include a frame containing at least the daylighting member, wherein the frame has at least two openings, one containing the daylighting member and the other serving as the ventilation hole.

In a further aspect of the present invention, the daylighting device may be configured to include an exhaust fan in the ventilation hole, the exhaust fan being configured to vent air via the ventilation hole from the light-entering side to the light-exiting side.

### Advantageous Effects of Invention

As described in the foregoing, according to one of aspects of the present invention, it is possible to provide a daylighting device capable of preventing thermal cracking of window glass and a substrate in the daylighting device by suppressing temperature increases between the window glass and the daylighting device.

### BRIEF DESCRIPTION OF DRAWINGS

FIG. 1 is a perspective view of the exterior of a window on which a daylighting device of a first embodiment is installed.

FIG. 2 is a cross-sectional view taken along line A-A′ in FIG. 1.

FIG. 3 is a cross-sectional view of the daylighting device.

FIG. 4 is a perspective view of a daylighting sheet.

FIG. 5A is a first perspective view illustrating a method of manufacturing the daylighting device.

FIG. 5B is a second perspective view illustrating the method of manufacturing the daylighting device.

FIG. 5C is a third perspective view illustrating the method of manufacturing the daylighting device.

FIG. 6A is a diagram showing an exemplary planar shape of a ventilation hole.

FIG. 6B is a diagram showing exemplary positions of overlapping through holes.

FIG. 7A is a first diagram showing an exemplary planar shape of a ventilation hole when viewed normal to a daylighting unit.

FIG. 7B is a second diagram showing an exemplary planar shape of a ventilation hole when viewed normal to a daylighting unit.

FIG. 7C is a third diagram showing an exemplary planar shape of a ventilation hole when viewed normal to a daylighting unit.

FIG. 7D is a fourth diagram showing an exemplary planar shape of a ventilation hole when viewed normal to a daylighting unit.

FIG. 7E is a fifth diagram showing an exemplary planar shape of a ventilation hole when viewed normal to a daylighting unit.

FIG. 8 is a diagram showing workings of the daylighting device.

FIG. 9 is a vertical cross-sectional view of a first light-entrance-prohibited region where sunlight is prohibited from entering the daylighting device.

FIG. 10 is a graph representing a relationship between the solar altitude and the height of region A₁ where no light is incident.

FIG. 11 is a graph representing a relationship between solar altitudes in Tokyo and relative sunshine durations for these solar altitudes over the course of 1 year.

FIG. 12 is a horizontal cross-sectional view of a second light-entrance-prohibited region where sunlight is prohibited from entering the daylighting device, as the daylighting device is viewed from a ceiling end thereof.

FIG. 13 is a graph representing a relationship between the solar azimuth and the region A₂ where no sunlight is incident.

FIG. 14A is a first front view showing the positions of ventilation holes formed.

FIG. 14B is a second front view showing the positions of ventilation holes formed.

FIG. 14C is a third front view showing the positions of ventilation holes formed.

FIG. 14D is a fourth front view showing the positions of ventilation holes formed.

FIG. 14E is a fifth front view showing the positions of ventilation holes formed.

FIG. 15A is a first representation of sunlight being directed only onto a daylighting sheet as viewed from the interior.

FIG. 15B is a second representation of sunlight being directed only onto a daylighting sheet as viewed from the interior.

FIG. 15C is a third representation of sunlight being directed only onto a daylighting sheet as viewed from the interior.

FIG. 16 is a perspective view of an anisotropic light-diffusion sheet made from a particle-dispersed film.

FIG. 17 is a diagram showing an exemplary daylighting member including functional members.

FIG. 18A is a first diagram showing another exemplary structure for the daylighting device.

FIG. 18B is a second diagram showing another exemplary structure for the daylighting device.

FIG. 18C is a third diagram showing another exemplary structure for the daylighting device.

FIG. 18D is a fourth diagram showing another exemplary structure for the daylighting device.

FIG. 19 is a schematic cross-sectional view of the structure of a daylighting device of a second embodiment.

FIG. 20A is another schematic cross-sectional view of the structure of the daylighting device of the third embodiment.

FIG. 20B is a cross-sectional view of a daylighting device that differs from the daylighting device in FIG. 20A in the positions of the centers of some of the through holes.

FIG. 21A is a cross-sectional view of optical paths through which incident light is transmitted when sunlight has a large azimuth, as the daylighting device is viewed from a ceiling end thereof.

FIG. 21B is a perspective view of through holes formed in a daylighting sheet.

FIG. 21C is a perspective view of through holes formed in a light-diffusion sheet.

FIG. 22 is a cross-sectional view of the overall structure of a daylighting device of a fourth embodiment.

FIG. 23 is a cross-sectional view of optical paths through which incident light is transmitted when sunlight has a large azimuth, as the daylighting device is viewed from a ceiling end thereof.

FIG. 24 is a front view of the overall structure of a daylighting device of a fifth embodiment.

FIG. 25 is a schematic cross-sectional view of the structure of the daylighting device of the fifth embodiment taken along line B-B′ in FIG. 24.

FIG. 26 is a front view of a first variation example of the daylighting device of the fifth embodiment.

FIG. 27 is a cross-sectional view of the daylighting device shown in FIG. 26 taken along line C-C′.

FIG. 28 is a front view of a second variation example of the daylighting device of the fifth embodiment.

FIG. 29 is a cross-sectional view of the daylighting device shown in FIG. 28 taken along line D-D′.

FIG. 30 is a front view of the overall structure of a daylighting device of a sixth embodiment.

FIG. 31 is a front view of the overall structure of a daylighting device of a seventh embodiment.

FIG. 32 is a cross-sectional view of the daylighting device shown in FIG. 31 taken along line E-E′.

FIG. 33A is a first diagram showing an exemplary structure of a ventilation hole.

FIG. 33B is a second diagram showing an exemplary structure of a ventilation hole.

FIG. 34 is a cross-sectional view, taken along line J-J′ in FIG. 35, of a room model in which a daylighting device and a lighting-modulation system are installed.

FIG. 35 is a plan view of a ceiling of the room model.

FIG. 36 is a graph representing a relationship between the illuminance produced by daylighting light (natural light) guided into the interior by a daylighting device and the illuminance produced by room lighting devices (lighting-modulation system).

### Description of Embodiments

The following will describe embodiments of the present invention in reference to drawings. In the drawings used in the following description, various members are drawn to suitable arbitrary scales to show each member with readily recognizable dimensions.

### First Embodiment

A daylighting device of the present embodiment is installed, for example, on a part of a window of an office building to guide sunlight into the building's interior.

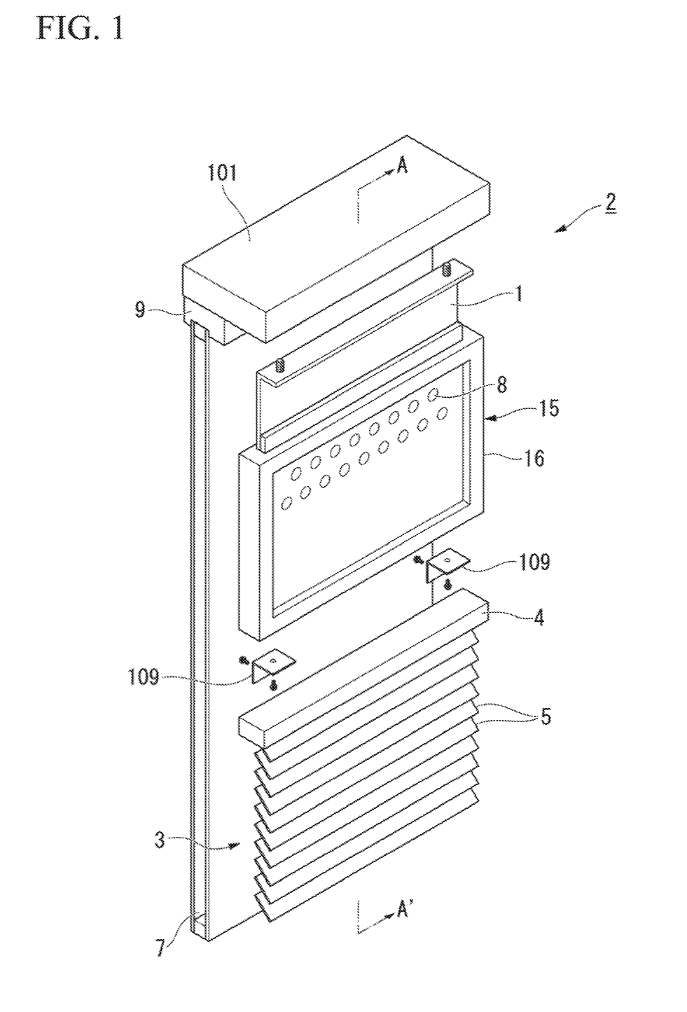

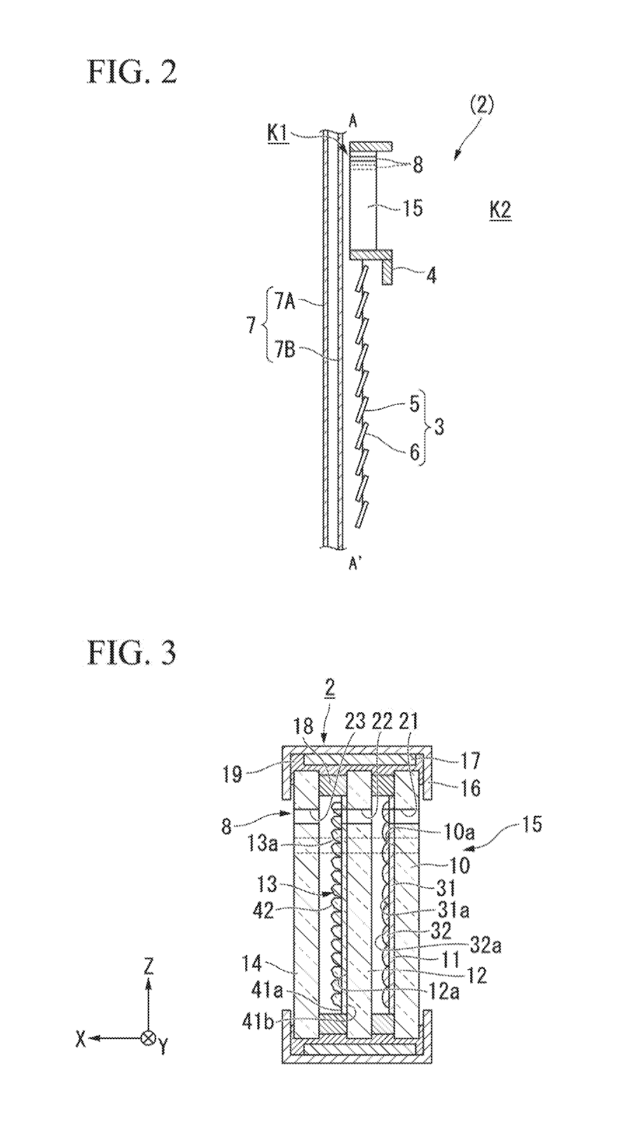

FIG. 1 is a perspective view of the exterior of a window on which a daylighting device of a first embodiment is installed. FIG. 2 is a cross-sectional view taken along line A-A′ in FIG. 1.

As shown in FIGS. 1 and 2, a daylighting device 2 is installed on a window frame 101 via an attaching unit 1, and a window shade 3 is disposed on a lower portion of the daylighting device 2. Take, as an example, a typical office room with a window that measures 270 cm in height (from the floor to the ceiling). The daylighting device 2 is located over the range of 70 cm from the ceiling. The window shade 3 covers approximately 200 cm below the daylighting device 2. The window shade 3 is attached to the bottom of the daylighting device 2, for example, via a pair of fixtures 109. The fixtures 109 are omitted in FIG. 2.

The window shade 3 has an upper portion thereof contained in a window shade box 4. The window shade 3 includes a plurality of slats 5 and ladder cords 6 stringing the slats 5. Each slat 5 is, for example, approximately 25 mm wide.

The window in this example is constructed from a window sash 9 and multilayered glass 7 set into the window sash 9. The multilayered glass 7 includes two glass panels 7A and 7B. This example employs a multilayered glass structure, which is susceptible to thermal cracking. Other structures, including single-layered glass and wire-reinforced glass, are also susceptible to thermal cracking.

The daylighting device 2, the window shade 3, and the multilayered glass 7, which is a part of the window, have a rectangular shape when viewed from the front. FIG. 2 does not show all the details of the structure of the daylighting device 2.

FIG. 3 is a cross-sectional view of the daylighting device 2.

The daylighting device 2 of the present embodiment, as shown in FIG. 3, includes a daylighting sheet (daylighting member) 13 that causes light having entered through one of the surfaces thereof to exit through the other surface with a predetermined angular distribution. Specifically, the daylighting device 2 of the present embodiment includes a daylighting unit 15 and a frame 16.

The daylighting unit 15 includes a first glass plate (transparent base member) 10, a light-diffusion sheet (light-diffusion member) 11, a second glass plate 12, the daylighting sheet 13, a third glass plate 14, the frame 16, a buffer material 17, an adhesive 18, and a caulking material 19.

In the present invention, the transparent base member may be, apart from the abovementioned glass plate, a base member made of a transparent resin such as an acrylic, a polycarbonate, or vinyl chloride.

The plurality of glass plates and sheets, namely the first glass plate 10, the light-diffusion sheet 11, the second glass plate 12, the daylighting sheet 13, and the third glass plate 14, are arranged in this sequence when viewed from the interior toward the exterior.

The daylighting sheet 13 of the present embodiment corresponds to the daylighting member recited in the claims. The light-diffusion sheet 11 of the present embodiment corresponds to the light-diffusion member recited in the claims.

In the following, for convenience of description, the exterior face of each glass plate will be referred to as the first face, whilst the interior face thereof will be referred to as the second face.

The light-diffusion sheet 11 is for diffusing the light traveling in the direction of a glare region and is attached to a first face 10a of the first glass plate 10. The daylighting sheet 13 is attached to a first face 12a of the second glass plate 12. The first glass plate 10, the second glass plate 12, and the third glass plate 14 are glass plates each approximately 3 to 6 mm thick and affixed together by the adhesive 18 with a gap between each other.

A layered body including the three layered glass plates 10, 12, and 14 has a peripheral portion thereof covered by the frame 16 made of a material such as aluminum or resin. Therefore, the frame 16 encloses inside thereof the three glass plates 10, 12, and 14 to which the light-diffusion sheet 11 and the daylighting sheet 13 are attached. The buffer material 17, made of rubber as an example, is provided between an end face of the layered body and the frame 16. The caulking material 19, composed primarily of a silicone as an example, fills the gap between the peripheral portion of the layered body and the frame 16.

The daylighting unit 15 is structured in this manner.

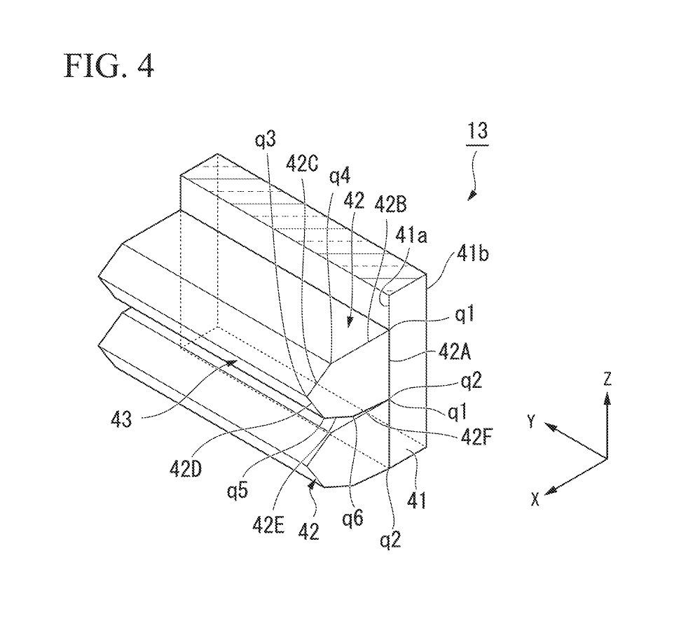

FIG. 4 is a perspective view of the daylighting sheet 13.

As shown in FIG. 4, the daylighting sheet 13 has formed thereon a fine structure on the scale of tens to hundreds of micrometers to guide external light, specifically sunlight, to the interior. The daylighting sheet 13 includes a film base member (first base member) 41, a plurality of protruding daylighting sections 42, and gap portions 43 provided between the daylighting sections 42. The daylighting sections 42 are arranged like stripes on a first face 41a of the film base member 41. The daylighting sections 42 are arranged to extend in the Y direction (horizontal direction) and sit side by side (parallel to each other) in the Z direction (vertical direction).

The film base member 41 is, for example, a light-transmitting base member made of, for example, a resin such as a thermoplastic polymer, a thermosetting resin, or a photopolymerizable resin. The film base member 41 is a base member having light-transmitting properties, such as an acrylic-based polymer, an olefin-based polymer, a vinyl-based polymer, a cellulose-based polymer, an amide-based polymer, a fluorine-based polymer, a urethane-based polymer, a silicone-based polymer, or an imide-based polymer. Specifically, the film base member 41 is preferably a base member having light-transmitting properties, such as a triacetyl cellulose (TAC) film, a polyethylene terephthalate (PET) film, a cycloolefin polymer (COP) film, a polycarbonate (PC) film, a polyethylene naphthalate (PEN) film, a polyethersulfone (PES) film, or a polyimide (PI) film. In the present embodiment, the film base member 41 is a 100 μm-thick PET film as an example. The film base member 41 preferably has a total light transmittance of, for example, 90% or higher.

This property renders the film base member 41 sufficiently transparent.

The daylighting sections 42 are made of an organic material having light-transmitting properties and photosensitivity, such as an acrylic resin, an epoxy resin, or a silicone resin. The resin is mixed with, for example, a polymerization initiator, a coupling agent, a monomer, and an organic solvent, to obtain a transparent resin mixture for use. The polymerization initiator may contain various additional components such as a stabilizer, an inhibitor, a plasticizer, a fluorescent whitening agent, a release agent, a chain transfer agent, and another photopolymerizable monomer. In the present embodiment, the daylighting sections 42 are made primarily of polymethyl methacrylate (PMMA) as an example. The daylighting sections 42 preferably have a total light transmittance of 90% or higher when measured as specified in JIS K7361-1.

This property renders the daylighting sections 42 sufficiently transparent.

In the present embodiment, the daylighting sections 42 are formed on the film base member 41 by thermal imprinting. The daylighting sections 42 may be formed by any process other than thermal imprinting, including UV imprinting, heat pressing, injection molding, extrusion molding, or compression molding. In melt extrusion, stamping, or another like method, the film base member 41 and the daylighting sections 42 are formed integrally from the same resin. Alternatively, a resin for shape transfer (UV transfer/heat transfer) may be applied onto a PET or like base film so that the structures can be molded by imprinting.

The daylighting sections 42 have a refractive index of around 1.5, ranging in the present embodiment from 1.35 if the primary material is mixed with a fluorine-based additive to approximately 1.6 if the primary material is mixed with a conjugated composition such as allyl groups. Each daylighting section 42 has a refractive index within this range.

Each daylighting section 42 is linearly elongate in one direction (Y direction in FIG. 4) and has a polygonal cross-section when cut along a plane perpendicular to the length of the daylighting section 42. Specifically, the cross-section of the daylighting section 42 is a hexagon with six apexes (q1 to q6) and all interior angles smaller than 180°. The daylighting sections 42 are arranged vertically so that the length of the daylighting section 42 becomes parallel to the horizontally extending sides of the rectangular film base member 41.

The first apex q1 and the second apex q2 of the hexagonal cross-section of the daylighting section 42 correspond to both ends of a first face 42A that contacts with the film base member 41. The fourth apex q4, the fifth apex q5, and the sixth apex q6 are not located on the first face 42A. The third apex q3 is located farthest from the first face 42A. The normal to the first face 42A that passes through the third apex q3 is longer than the normals to the first face 42A that pass the other apexes q1, q2, and q4 to q6. The daylighting section 42 is asymmetric with respect to the normal to the first face 42A that passes through the third apex q3.

The daylighting section 42 is by no means limited to this shape and may have a pentagonal, trapezoidal, or triangular cross-section when cut perpendicular to the length of the daylighting section 42.

Referring to FIG. 3, the daylighting sheet 13 is disposed on the first face 12a of the second glass plate 12 so that the daylighting sections 42 have lengths thereof in the horizontal direction and sit side by side in the vertical direction (Z direction). The daylighting sheet 13 has a second face 41b side thereof attached to the second glass plate 12, with the first face 41a of the film base member 41 carrying thereon a fine structure formed by the daylighting sections 42 and facing the exterior (the third glass plate 14 side). When the daylighting device 2 is installed on the window, the daylighting sheet 13 is disposed in such an orientation that the daylighting section 42, having a hexagonal cross-section shown in FIG. 4, has a second face 42B and a third face 42C thereof both facing vertically upward and a fourth face 42D, a fifth face (reflective face) 42E, and a sixth face (reflective face) 42F thereof all facing vertically downward.

The film base member 41 desirably has a refractive index that is substantially equal to the refractive index of the daylighting sections 42 for the following reasons. If, for example, there is a large difference between the refractive index of the film base member 41 and the refractive index of the daylighting sections 42, light may undesirably be refracted or reflected at the interface between the daylighting sections 42 and the film base member 41 as the light enters the film base member 41 from the daylighting sections 42. These phenomena could lead to unfavorable results, including reduced luminance and a failure to achieve desired daylighting properties.

The gap portions 43 contain air therein and therefore have a refractive index of approximately 1.0. Specifying the refractive index of the gap portions 43 to 1.0 minimizes the critical angle of an interface (air interface) 43a between the daylighting sections 42 and the gap portions 43.

The light-diffusion sheet 11 has such anisotropy in light-diffusion properties as to exhibit stronger light-diffusion properties in the vertical direction (in the YZ plane) than in the horizontal direction (in the XY plane). Referring to FIG. 3, the light-diffusion sheet 11 has a lenticular lens structure including a base member 31 and a plurality of convex lens portions 32 provided on a first face 31a of the base member 31. The light-diffusion sheet 11 is attached to the first face 10a of the first glass plate 10 (the first face 10a faces the second glass plate 12), in such an orientation that the convex lens portions 32 face the second glass plate 12. The convex lens portions 32 are arranged to extend in the Y direction (horizontal direction) and sit side by side (parallel to each other) in the Z direction (vertical direction).

Each convex lens portion 32 has a convex face 32a having a curvature in the vertical plane and no curvature in the horizontal direction. The convex lens portion 32 therefore has strong light-diffusion properties in the vertical direction (in the YZ plane) and no light-diffusion properties in the horizontal direction (in the XY plane). Hence, the light incident to the light-diffusion sheet 11 is significantly diffused in the vertical direction (in the YZ plane), but hardly diffused in the horizontal direction (in the XY plane) as the light exits the convex lens portions 32.

The convex lens portions 32 may be fabricated from the first face 31a itself of the base member 31 and thus integral to the base member 31 or may be physically separate from the base member 31. The light-diffusion sheet 11 may have no lenticular lens structure or other like regular structure and may have a plurality of irregularly arranged convex portions. Alternatively, the light-diffusion sheet 11 may be fibrous or ellipsoidal light-diffusion particles dispersed in a light-transmitting resin layer serving as a medium in such a manner that the particles become aligned in the horizontal direction.

In the present embodiment, the light-diffusion sheet 11 is used that has such anisotropy that light is significantly diffused in the vertical direction (in the YZ plane). Alternatively, a light-diffusion sheet may be used that has such anisotropy that light is significantly diffused in the horizontal direction (in the XY plane) or that has isotropic light-diffusion properties.

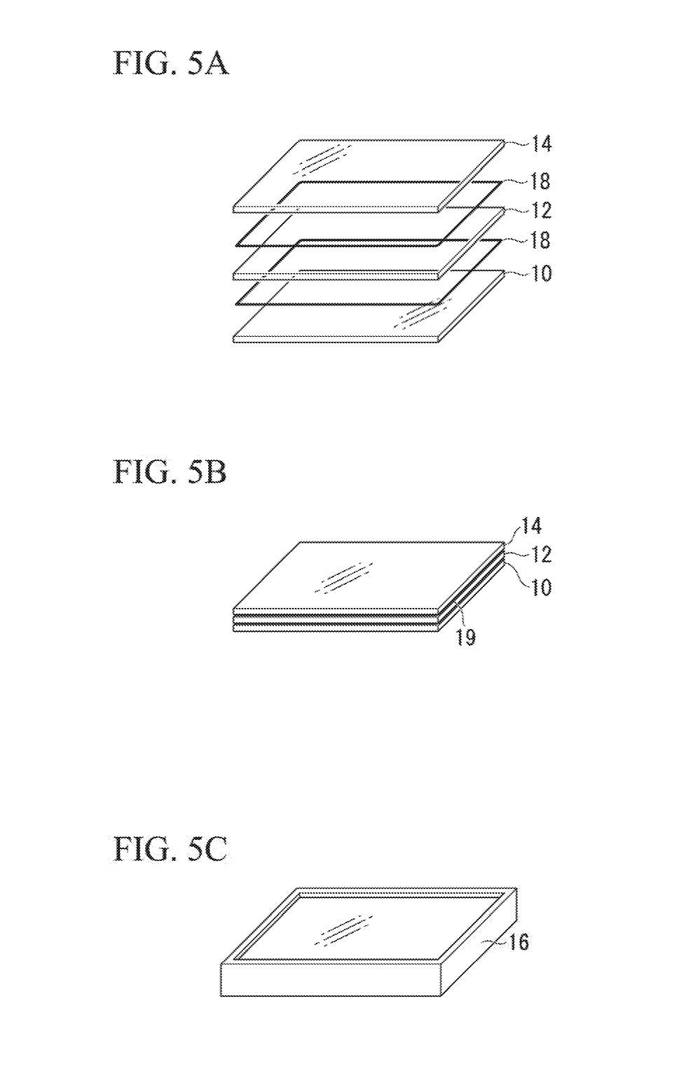

The following will describe a method of manufacturing the daylighting device 2 having the structure described above, in reference to FIGS. 5A to 5C.

To manufacture the daylighting device 2, the first glass plate 10 to which the light-diffusion sheet 11 is attached, the second glass plate 12 to which the daylighting sheet 13 is attached, and the third glass plate 14 are prepared. None of these sheets are shown. The sheets may be, for example, dry-attached to the first glass plate 10, the second glass plate 12, and the third glass plate 14 using an acrylic-based adhesive or water-attached using a water-attaching adhesive while fine-tuning the attaching positions thereof.

Next, the first glass plate 10, the second glass plate 12, and the third glass plate 14 to which the three sheets are attached are affixed together with a gap between each other as shown in FIG. 5A. In the affixing, the front and back faces of the first glass plate 10, the second glass plate 12, and the third glass plate 14 are orientated as shown in FIG. 3. The rubbery adhesive 18 dispensed like a frame is interposed between the first glass plate 10 and the second glass plate 12 and between the second glass plate 12 and the third glass plate 14. The adhesive 18 affixes the glass plates with each other and also serves as spacer that maintains distances that separate the glass plates.

Now referring to FIG. 5B, the caulking material 19 is applied around the three affixed glass plates 10, 12, and 14 to integrate and prevent the three glass plates 10, 12, and 14 from easily becoming loose.

Next, as shown in FIG. 5C, the frame 16 is attached around the three integrated glass plates 10, 12, and 14. In the attaching of the frame 16, the buffer material 17 (not shown) is inserted between the three glass plates 10, 12, and 14 and the frame 16 to prevent the three glass plates 10, 12, and 14 from coming into contact with the frame 16 and mitigate the impact of external force exerted on the frame 16.

Next, the features of the daylighting device 2 of the present embodiment will be described.

In the present embodiment, the daylighting unit 15 has a plurality of ventilation holes 8 formed therethrough in the thickness direction of the daylighting unit 15 as shown in FIGS. 1 to 3. These ventilation holes 8 function as holes spatially connecting a space K1 on the multilayered glass 7 to an indoor-side space K2 separated from the space K1 by the daylighting unit 15.

The ventilation holes 8 include a plurality of through holes formed through structural members. Specifically, each ventilation hole 8 of the present embodiment includes a through hole 21 extending in the thickness direction of the first glass plate 10, a through hole 22 extending in the thickness direction of the second glass plate 12, a through hole 23 extending in the thickness direction of the third glass plate 14, a through hole (second through hole) 11a extending in the thickness direction of the light-diffusion sheet 11, and a through hole (first through hole) 13a extending in the thickness direction of the daylighting sheet 13.

In this embodiment, the through holes 21 may be formed after combining the first glass plate 10 and the light-diffusion sheet 11 together. Alternatively, holes may be formed in advance through the first glass plate 10 and the light-diffusion sheet 11 before the first glass plate 10 and the light-diffusion sheet 11 are combined to each other to form the through holes 21.

Likewise, the through holes 22 may be formed after combining the second glass plate 12 and the daylighting sheet 13 together. Alternatively, holes may be formed in advance through the second glass plate 12 and the daylighting sheet 13 before the second glass plate 12 and the daylighting sheet 13 are combined to each other to form the through holes 22.

Depending on fabrication tools and methods, the through holes 21, 22, and 23 in the glass plates 10, 12, and 14 can be formed in sizes from 3 mm (smallest diameter) or larger. The opening of the holes through the glass plates 10, 12, and 14 could lower the structural strength of those parts of the glass plates 10, 12, and 14 at which the through holes 21, 22, and 23 are formed. The glass plates 10, 12, and 14 are preferably made of toughened glass.

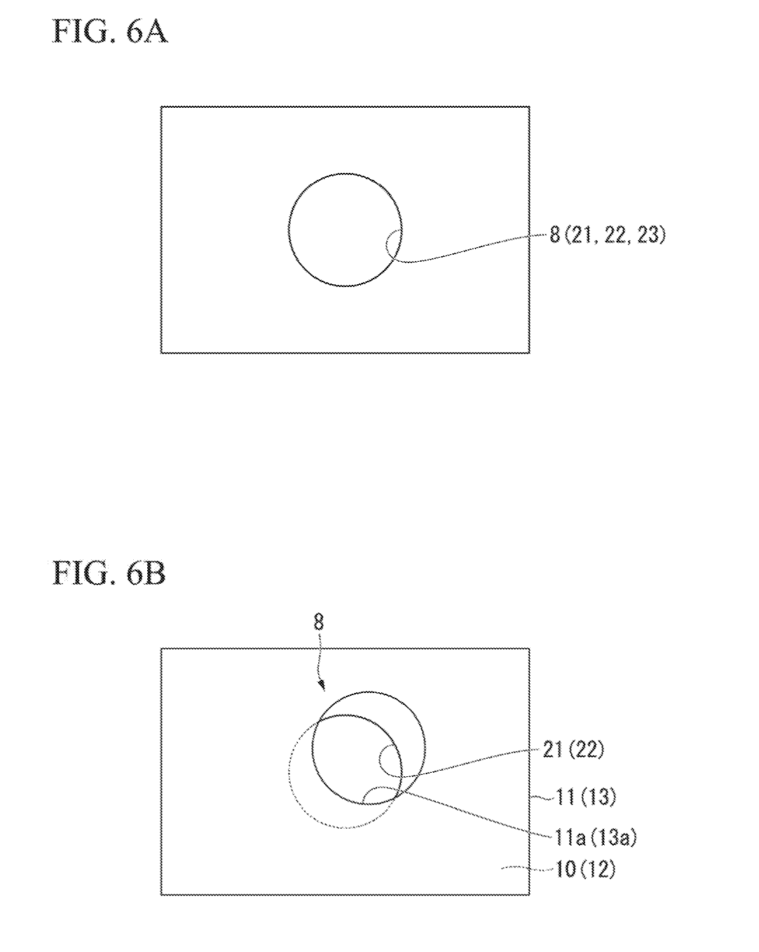

FIG. 6A is a diagram showing an exemplary planar shape of the ventilation hole 8. FIG. 6B is a diagram showing exemplary positions of the overlapping through holes 21, 22, and 23.

The through holes 21, 22, and 23, constituting the ventilation hole 8, are preferably formed in the same size and the same shape and arranged concentrically when viewed normal to the daylighting unit 15 as shown in FIG. 6A.

This is, however, by no means the only possible configuration. The positions of the centers of the through holes 21, 22, and 23, constituting the ventilation hole 8, may be slightly out of alignment. For example, as shown in FIG. 6B, the positions of the centers of the through holes 21 and 11a formed in advance in the first glass plate 10 and the light-diffusion sheet 11 may become out of alignment when the first glass plate 10 and the light-diffusion sheet 11 are combined. The same description applies to holes formed in advance in the second glass plate 12 and the daylighting sheet 13. The through holes 21, 22, and 23 function as the ventilation hole 8 of the daylighting unit 15 as long as the through holes 21, 22, and 23 at least partially overlap each other when viewed normal to the daylighting unit 15.

The ventilation hole 8, as well as the through holes 21, 22, and 23 constituting the ventilation hole 8, has a cornerless planar shape. If the through holes 21, 22, and 23 have a planar shape with a corner, cracks could start at the corner and grow to eventually damage the glass plates. Therefore, the through holes 21, 22, and 23 have a curved surface with no corners under any conditions.

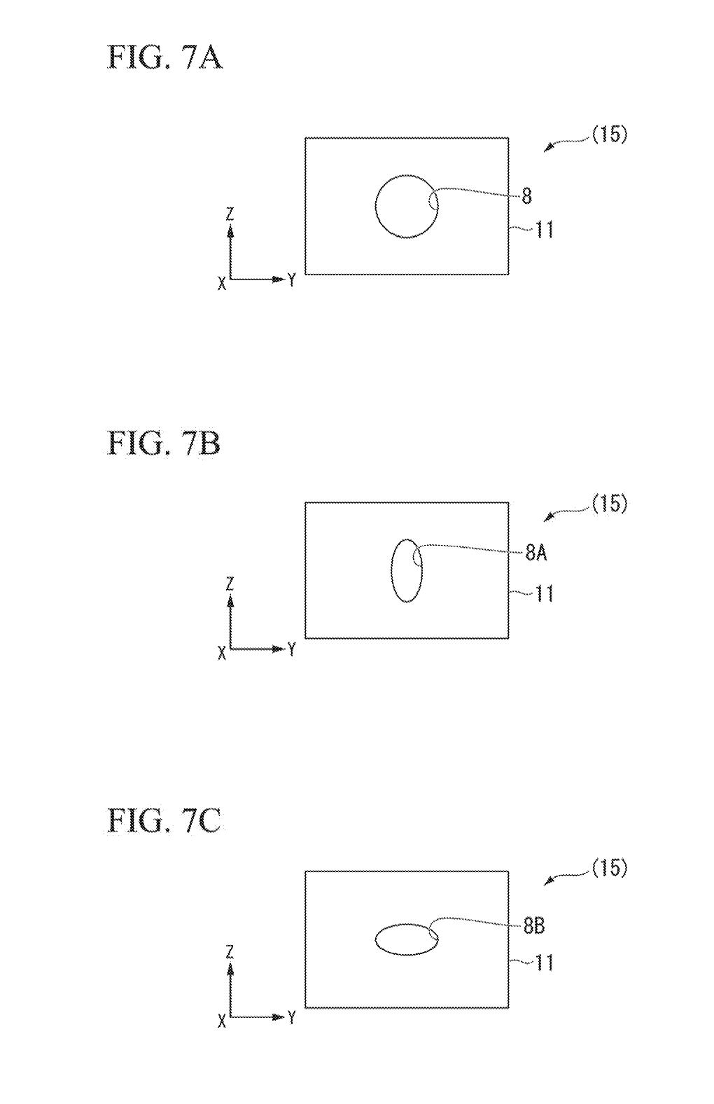

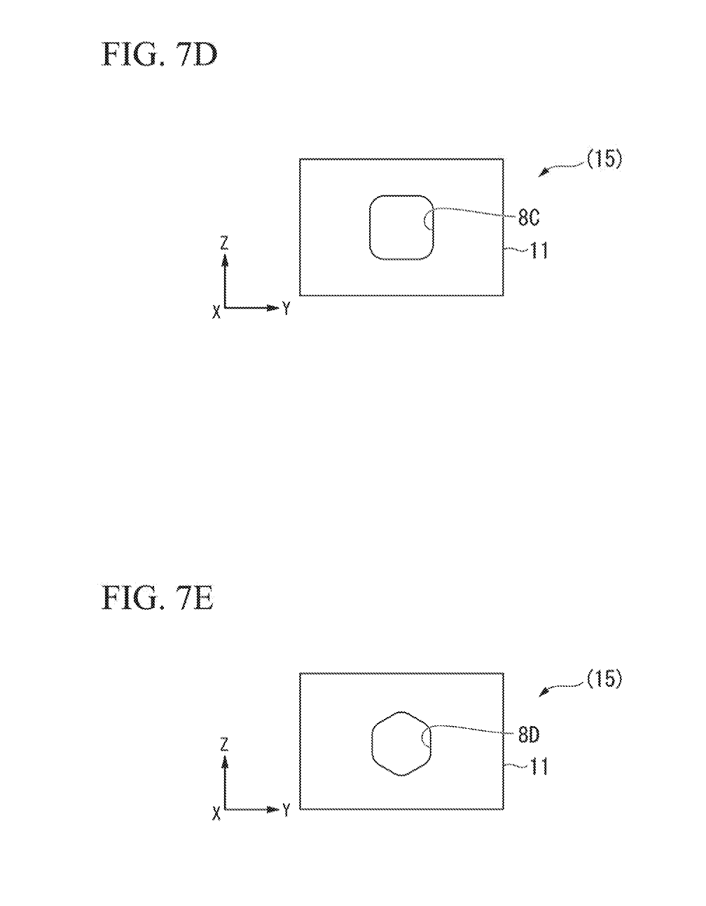

FIGS. 7A to 7E are diagrams showing exemplary planar shapes of ventilation holes when viewed normal to the daylighting unit 15.

In the present embodiment, the ventilation hole 8 has a circular planar shape as shown in FIG. 7A. This is, however, by no means the only possible configuration. For example, the ventilation hole 8 may have an elliptical planar shape having a major axis in a direction that intersects the lengthwise direction of the daylighting sections 42 shown in FIG. 4 (e.g., Z direction). See, for example, a ventilation hole 8A shown in FIG. 7B. As another example, the major axis may be in the extension direction (Y direction) of the daylighting sections 42. See, for example, a ventilation hole 8B shown in FIG. 7C. Alternatively, the ventilation hole 8 may have a polygonal planar shape with rounded corners. See, for example, ventilation holes 8C and 8D shown in FIGS. 7D and 7E.

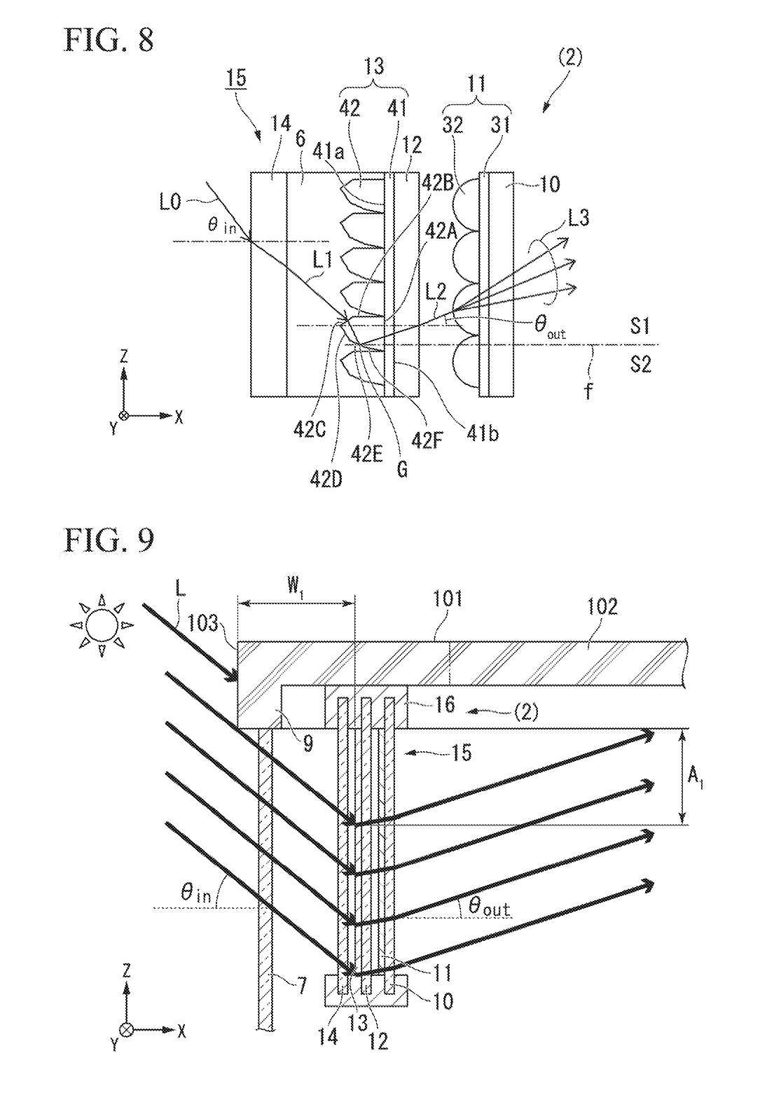

The workings of the daylighting device 2 of the present embodiment will be described in reference to FIG. 8, which is a diagram showing a part of the daylighting device 2 with the ventilation holes 8 and other members being omitted.

For convenience of description, an incident point G is defined as the point at which an arbitrary single light flux that is part of the light entering the daylighting section 42 shown in FIG. 8 is incident on the fifth face (reflective face) 42E of the daylighting section 42. Also, a straight line f is defined as the imaginary straight line that passes through the incident point G and is perpendicular to the first face 41a of the film base member 41. Additionally, a first space S1 is one of the two spaces bordering at the horizontal plane containing the straight line f in which space there exists light L1 incident at the incident point G, whilst a second space S2 is the other one of the two spaces in which space there is no light L1 incident at the incident point.

Referring to FIG. 8, light L0 entering the daylighting device 2 obliquely from above at an angle of incidence θᵢₙ≧0° is refracted by the third glass plate 14 and enters the daylighting sheet 13 obliquely from above.

The light L1 enters the daylighting section 42 in the daylighting sheet 13, for example, through the third face 42C and is refracted, travels in the direction of the fifth face 42E where the light L1 is reflected, after which the light L1 exits the second glass plate 12 at an angle of emergence θₒᵤₜ≧0° in the direction of the first space S1. Light L2 exiting the second glass plate 12 enters the light-diffusion sheet 11 and is diffused by the convex lens portion 32 in the vertical plane (in the XZ plane).

Light L3, produced by diffusing in the light-diffusion sheet 11, travels in the direction of the room ceiling and illuminates well deep into the room. Therefore, by using the daylighting device 2, one can efficiently guide external light (sunlight) in the direction of the room ceiling. That in turn renders the room brighter without causing occupants of the room to feel glare.

The optical paths described above are mere examples. The external light entering the daylighting device 2 enters the daylighting section 42 in the daylighting sheet 13 either through the second face 42B or through the third face 42C. The light is then reflected by one of the fourth face 42D, the fifth face 42E, and the sixth face 42F and exits the daylighting section 42 through the first face 42A. Light can take one of these or other optical paths in passing through the daylighting section 42.

If the daylighting device 2 is installed with no gap between the daylighting device 2 and the window frame 101 or a nearby ceiling 102 as in the present embodiment, there is a chance that the air heated by sunlight irradiation could remain in the space K1 between the multilayered glass 7 and the daylighting device 2. Air has such properties that when its temperature rises, it expands and becomes less dense (relatively light), thereby moving upward, and conversely, when its temperature falls, it becomes denser (relatively heavy), thereby moving downward.

Therefore, if the multilayered glass 7 or the daylighting device 2 is warmed up by sunlight irradiation and there is not a sufficient gap between the daylighting device 2 and the multilayered glass 7, heat builds up in the space K1 between the daylighting device 2 and the multilayered glass 7, creating a local high-temperature condition. This in turn increases temperature difference between those parts of the multilayered glass 7 which face the daylighting device 2 and those which do not face the daylighting device 2. The increased temperature difference generates stress in the glass surface and renders the multilayered glass 7 susceptible to thermal cracking in which the multilayered glass 7 is partially damaged.

Here, thermal cracking in ordinary window glass will be described in detail. Irradiated regions of window glass where the glass is directly irradiated by sunlight absorb light, heat up, and expand. In contrast, peripheral parts of the window glass are not irradiated by sunlight because these parts are inserted inside a window sash. The peripheral parts also lose heat to the window sash and the window frame. The peripheral parts therefore remain cool and do not expand. For these reasons, the thermal expansion of the irradiated regions is inhibited by the peripheral parts, which means that tensile stress (thermal stress) is generated in the peripheral regions of the window glass. This thermal stress is proportional to the temperature difference between the irradiated regions and the peripheral regions. Thus, when tensile stress grows in excess of the edge strength of the window glass, the window glass is broken. This phenomenon is called thermal cracking.

Window glass is most susceptible to thermal cracking during the morning hours on a sunny winter day because air is clear on many winter days, and insolation increases, especially, on the southern side of the building while the window sash and the periphery thereof have low temperature.

Referring to FIG. 3 again, the daylighting device 2 of the present embodiment includes the glass plates 10, 12, and 14 and hence has sealed air layers therein. The daylighting device 2, having sealed air layers therein, restrains internal air current generation, which effects high thermal insulation. On the other hand, the sealed air layers are likely to become a cause for local temperature increase. This mechanism also renders the glass substrates in the daylighting device 2 susceptible to thermal cracking.

To avoid such problems, in the present embodiment, there are formed the plurality of ventilation holes 8 extending through the thickness of the daylighting unit 15. The ventilation holes 8 are formed in the upper portion of the daylighting unit 15 and hence can readily catch expanding and ascending warm air thereinto.

The warm air remaining in the space K1 (see FIG. 2) between the multilayered glass 7 and the daylighting device 2 can thus flow into the indoor-side space K2 (see FIG. 2) via the ventilation holes 8. That in turn reduces the temperature difference between the space K1 (located on the multilayered glass 7 side) and the indoor-side space K2 separated by the daylighting device 2 from the space K1. As a result, thermal cracking which could be caused under sunlight irradiation is prevented, and damage to the multilayered glass 7 is prevented.

The daylighting device 2 is often installed at a high place in the room. Therefore, in the space K1 between the multilayered glass 7 and the daylighting device 2, temperature tends to rise near the ceiling end thereof. The ventilation holes 8, provided in large numbers at positions close to the ceiling end as in the daylighting device 2 of the present embodiment, therefore facilitate the flow of the warm air in the space K1 to the indoor-side space K2, which increases ventilation efficiency.

Furthermore, as mentioned earlier, thermal cracking could occur not only in the multilayered-glass structure, not also in other window structures that include, for example, single-layered glass or wire-reinforced glass. The provision of the ventilation holes 8 as in the present embodiment can prevent thermal cracking of, and damage to, the window glass.

Next will be described a relationship between the solar altitude and the positions of the ventilation holes 8.

FIG. 9 is a vertical cross-sectional view of a first light-entrance-prohibited region A₁ where sunlight is prohibited from entering the daylighting device 2.

As shown in FIG. 9, part of sunlight L entering the daylighting device 2 at a predetermined solar altitude (angle of incidence θᵢₙ) is in some cases blocked by eaves 103 of the building or the window sash 9. In other words, in the upper portion of the daylighting device 2, there can be a region where no sunlight can enter (hereinafter, the “first light-entrance-prohibited region A₁”), depending on the angle of incidence θᵢₙ of the sunlight L.

Referring to FIG. 9, letting W₁ (mm) represent the distance from the exterior face of either the building's eaves 103 or the window sash 9 to the exterior face of the daylighting sheet 13 in the daylighting device 2, the height (mm) of the first light-entrance-prohibited region A₁ is given by the following mathematical expression:

Height (mm) of First Light-entrance-prohibited Region A₁=W₁ tan θᵢₙ (1)

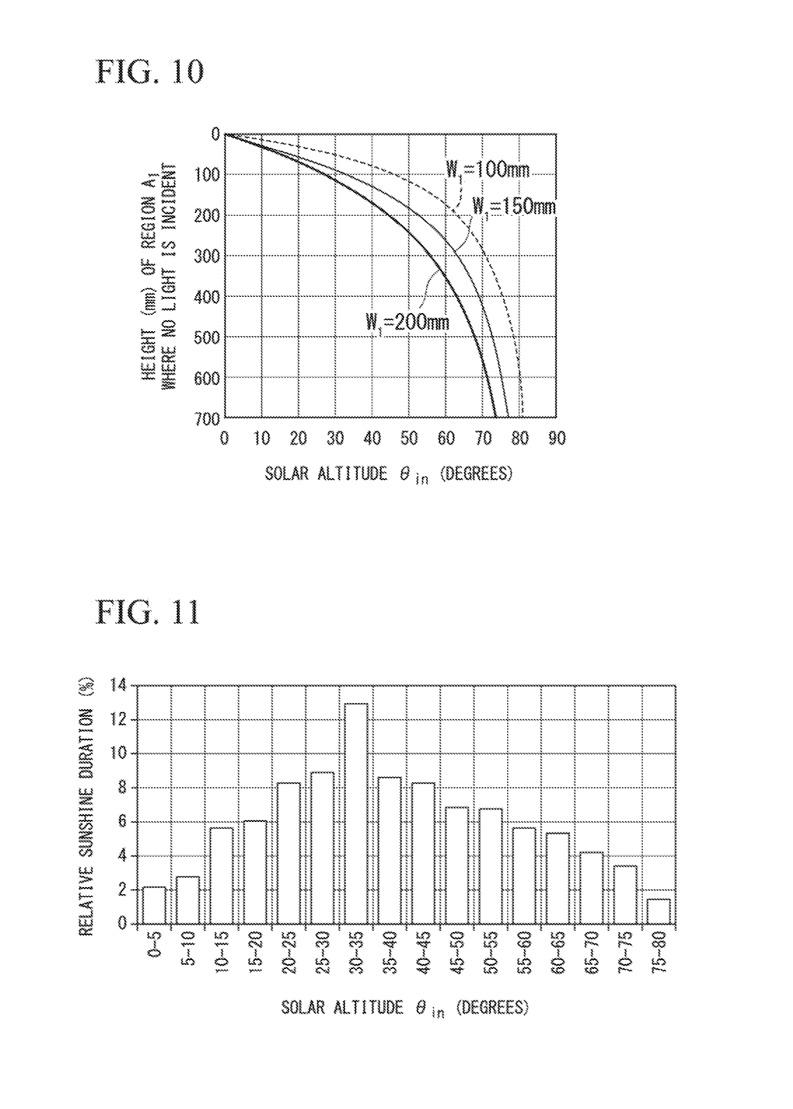

FIG. 10 is a graph representing a relationship between the solar altitude and the height of region A₁ where no light is incident. In FIG. 10, the horizontal axis indicates the solar altitude θᵢₙ (degrees), and the vertical axis indicates the height (mm) of the first light-entrance-prohibited region A₁.

The relationship between the solar altitude and the first light-entrance-prohibited region A₁ was studied by changing the distance W₁ from the exterior face of the window frame 101 to the exterior face of the daylighting sheet 13 in the daylighting device 2 to 100 mm, 150 mm, and 200 mm.

It is understood from FIG. 10 that the first light-entrance-prohibited region A₁ increases with an increase in the solar altitude for all the distances W₁ from the exterior face of the window frame 101 to the exterior face of the daylighting sheet 13. It is also understood that for the same solar altitude, the height of the first light-entrance-prohibited region A₁ decreases with a decrease in the distance W₁ from the exterior face of the window frame 101 to the exterior face of the daylighting sheet 13, that is, with a decrease in the distance between the multilayered glass 7 and the daylighting device 2.

FIG. 11 is a graph representing a relationship between solar altitudes in Tokyo and relative sunshine durations for these solar altitudes over the course of 1 year. In FIG. 11, the horizontal axis indicates the solar altitude θᵢₙ (degrees), and the vertical axis indicates the relative sunshine duration (%) for each solar altitude. Here, daily measurement started at 8 o'clock in the morning and finished at 6 o'clock in the evening. (i) Changes in the solar altitude and (ii) the relative sunshine duration for each solar altitude during this time period were measured over the course of 1 year (3,650 hours).

The solar altitude with long sunshine durations over the period of 1 year is in the range of 30° to 35° as shown in FIG. 11. The relative sunshine duration peaks at solar altitudes of 30° to 35° and changes almost symmetrically above and below that range of solar altitude.

As mentioned earlier, the first light-entrance-prohibited region A₁ of the daylighting device 2 receives no sunlight, achieving no daylighting function. Therefore, the ventilation holes 8 are preferably formed in this first light-entrance-prohibited region A₁. If the first light-entrance-prohibited region A₁ is determined from mathematical expression (1) above by using as the standard the solar altitude at which the sunshine duration is longest over the year, the ventilation holes 8 can be formed without substantially affecting the daylighting function of the daylighting device 2.

Although the ventilation holes 8 are preferably formed in the first light-entrance-prohibited region A₁, there are other points that should be considered. The daylighting function of the daylighting device 2 deteriorates with an increase in area of the first light-entrance-prohibited region A₁. A smaller first light-entrance-prohibited region A₁ increases the region through which sunlight can enter and hence ensures the daylighting function of the daylighting device 2. For these reasons, the daylighting device 2 is preferably located close to the multilayered glass 7 to minimize the first light-entrance-prohibited region A₁. This configuration can prevent large increases in the first light-entrance-prohibited region A₁ even when the solar altitude changes, and hence can render the daylighting device 2 more tolerant of large changes of the solar altitude.

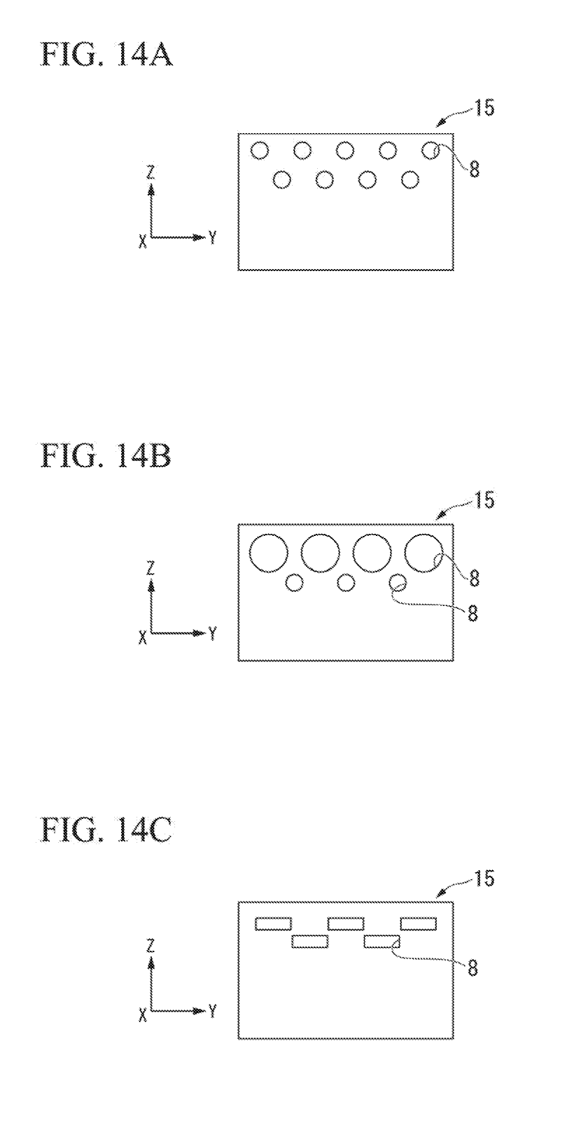

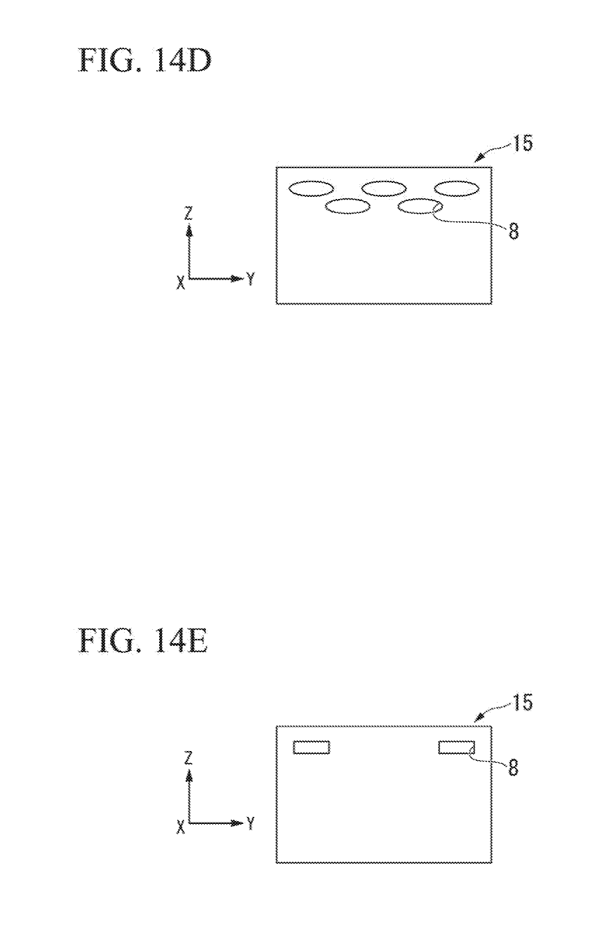

In addition, as shown in FIG. 9, the first light-entrance-prohibited region A₁ will likely form in the upper portion of the daylighting device 2 even when the solar altitude changes. Therefore, the ventilation holes 8 are formed in the top portion of the daylighting unit 15 whenever possible as shown in FIGS. 14A to 14E. It is also preferable, but not essential, to provide many ventilation holes 8 in the first light-entrance-prohibited region A₁.

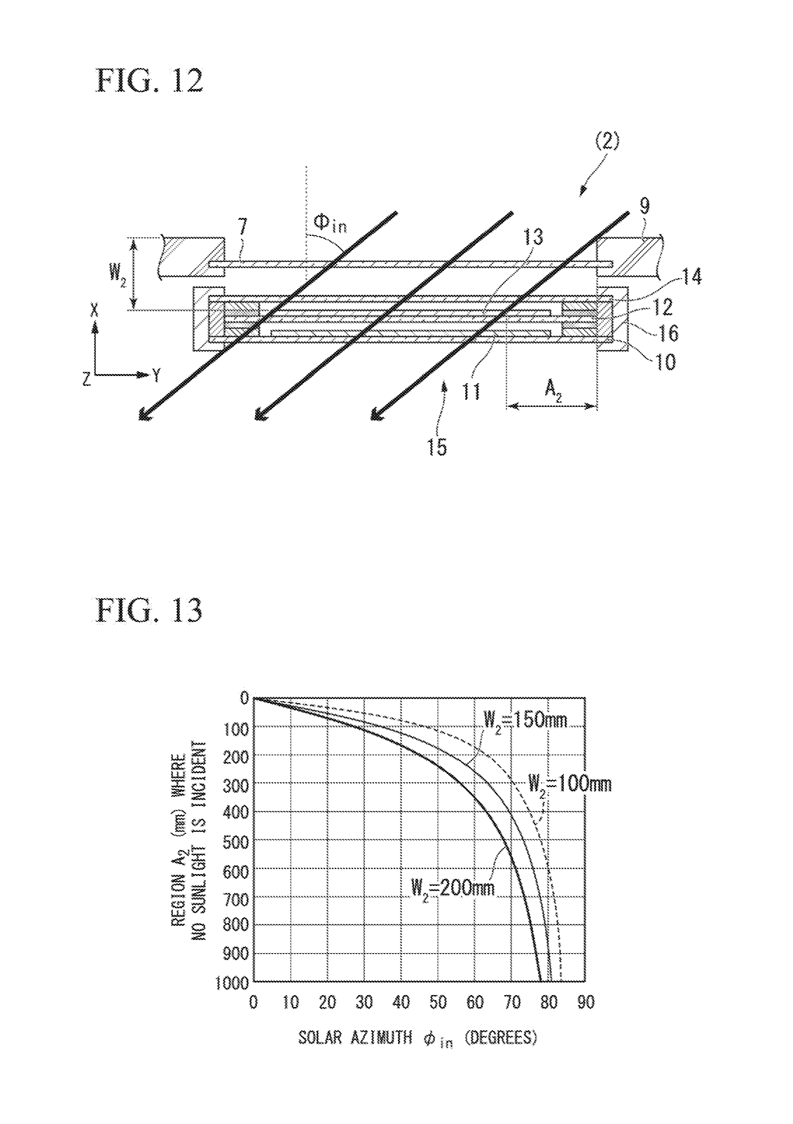

FIG. 12 is a horizontal cross-sectional view of a second light-entrance-prohibited region A₂ where sunlight is prohibited from entering the daylighting device 2, as the daylighting device 2 is viewed from a ceiling end thereof.

As shown in FIG. 12, part of the sunlight L entering the daylighting device 2 at a predetermined solar azimuth Φᵢₙ is in some cases blocked, for example, by the window sash 9. In other words, there can be a region A₂ where no sunlight L can enter (hereinafter, the “second light-entrance-prohibited region A₂”) along the left or right side of the daylighting device 2, depending on the azimuth Φᵢₙ of the sunlight L.

Referring to FIG. 12, letting W₂ (mm) represent the distance from the exterior face of the window sash 9 to the exterior face of the daylighting sheet 13 in the daylighting device 2, the width (mm) of the second light-entrance-prohibited region A₂ is given by the following mathematical expression:

Width (mm) of Second Light-entrance-prohibited Region A₂=W₂ tan Φᵢₙ (2)

FIG. 13 is a graph representing a relationship between the solar azimuth and the second light-entrance-prohibited region A₂. In FIG. 13, the horizontal axis indicates the solar azimuth Φᵢₙ (degrees), and the vertical axis indicates the height of the second light-entrance-prohibited region A₂.

The relationship between the solar azimuth Φ and the second light-entrance-prohibited region A₂ was studied by changing the distance W₂ from the exterior face of the window sash 9 to the exterior face of the daylighting sheet 13 in the daylighting device 2 to 100 mm, 150 mm, and 200 mm.

It is understood from FIG. 13 that the width (mm) of the second light-entrance-prohibited region A₂ increases with an increase in the solar azimuth Φᵢₙ (degrees) for all the distances W₂ from the exterior face of the window sash 9 to the exterior face of the daylighting sheet 13. It is also understood that for the same solar azimuth, the height of the second light-entrance-prohibited region A₂ decreases with a decrease in the distance from the exterior face of the window sash 9 to the exterior face of the daylighting sheet 13, that is, with a decrease in the distance between the multilayered glass 7 and the daylighting device 2.

As mentioned earlier, the second light-entrance-prohibited region A₂ of the daylighting device 2 receives no sunlight, achieving no daylighting function. Therefore, the ventilation holes 8 are preferably formed in this second light-entrance-prohibited region A₂. If the second light-entrance-prohibited region A₂ is determined from mathematical expression (2) above in reference to the graph in FIG. 11 by using as the standard the solar direction at which the sunshine duration is longest over the year, the ventilation holes 8 can be formed without substantially affecting the daylighting function of the daylighting device 2. Additionally, the daylighting device 2, if located close to the multilayered glass 7, can prevent large increases in the second light-entrance-prohibited region A₂ even when the solar azimuth changes, and hence can render the daylighting device 2 more tolerant of large changes of the solar azimuth.

In addition, as shown in FIG. 12, the second light-entrance-prohibited region A₂ will likely form along one of the left and right sides of the daylighting device 2 even when the solar azimuth changes. Therefore, it is preferable to provide many ventilation holes 8 in the second light-entrance-prohibited region A₂. For example, the ventilation holes 8 are formed along the far left and right sides of the daylighting unit 15 whenever possible as shown in FIG. 14E.

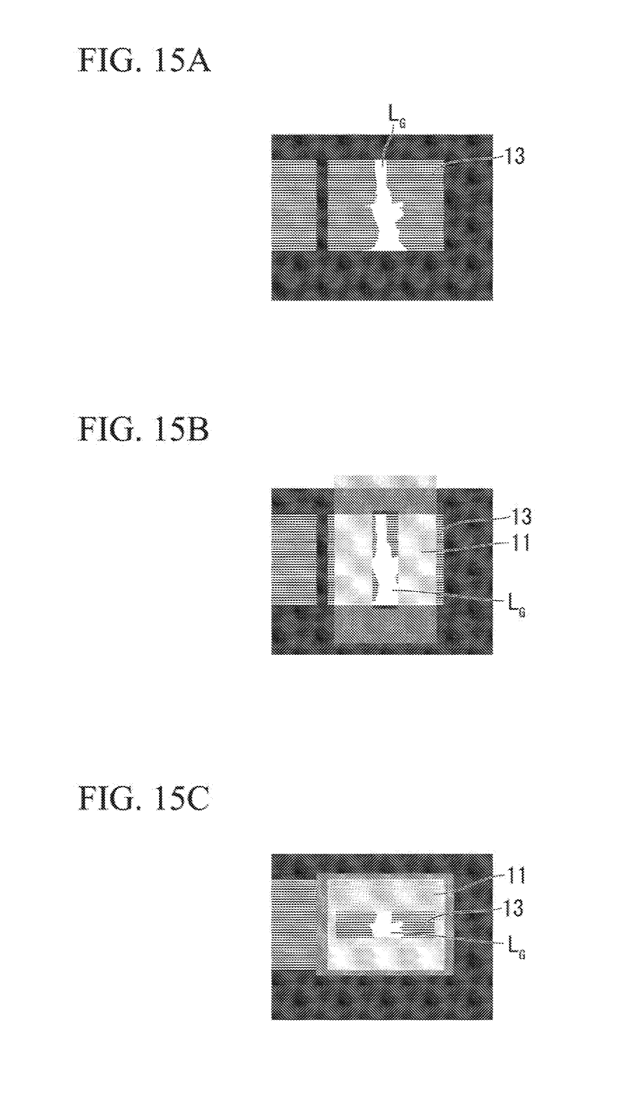

Next will be described a relationship between through holes in the daylighting sheet 13 and through holes in the light-diffusion sheet 11 in reference to FIGS. 15A to 15C.

FIG. 15A is a representation of sunlight being directed only onto the daylighting sheet 13 as viewed from the interior. FIG. 15A shows that part of the light exiting the daylighting sheet 13 that is diffused in a direction (Z direction) that intersects the extension direction of the daylighting sections 42 is visually recognized as glare L_{G}. In other words, the light that has transmitted only through the daylighting sheet 13 is visually recognized as vertical, linear glare L_{G} by occupants.

Therefore, as shown in FIG. 15B, if the through holes (second through holes) 11a in the light-diffusion sheet 11 disposed on the indoor side of the daylighting sheet 13 are arranged so that the lengthwise direction of the through holes 11a matches the direction (Z direction) that intersects the extension direction of the daylighting sections 42, the glare L_{G} passes through the ventilation holes 8 without being obstructed and makes the occupant feel the glaring.

Accordingly, the lengthwise direction of the through holes 11a in the light-diffusion sheet 11 is matched with the extension direction of the daylighting sections 42 (Y direction) as shown in FIG. 15C. This configuration allows only part of the glare L_{G} to pass through the through holes 11a, which reduces the area in which the vertical, linear glare L_{G} can be visually recognized by an occupant.

For these reasons, if the through holes 11a are provided in the light-diffusion sheet 11, the left/right direction of the light-diffusion sheet 11 preferably matches the lengthwise direction of the through holes 11a to suppress the glare L_{G} exiting the daylighting sheet 13 from entering the interior.

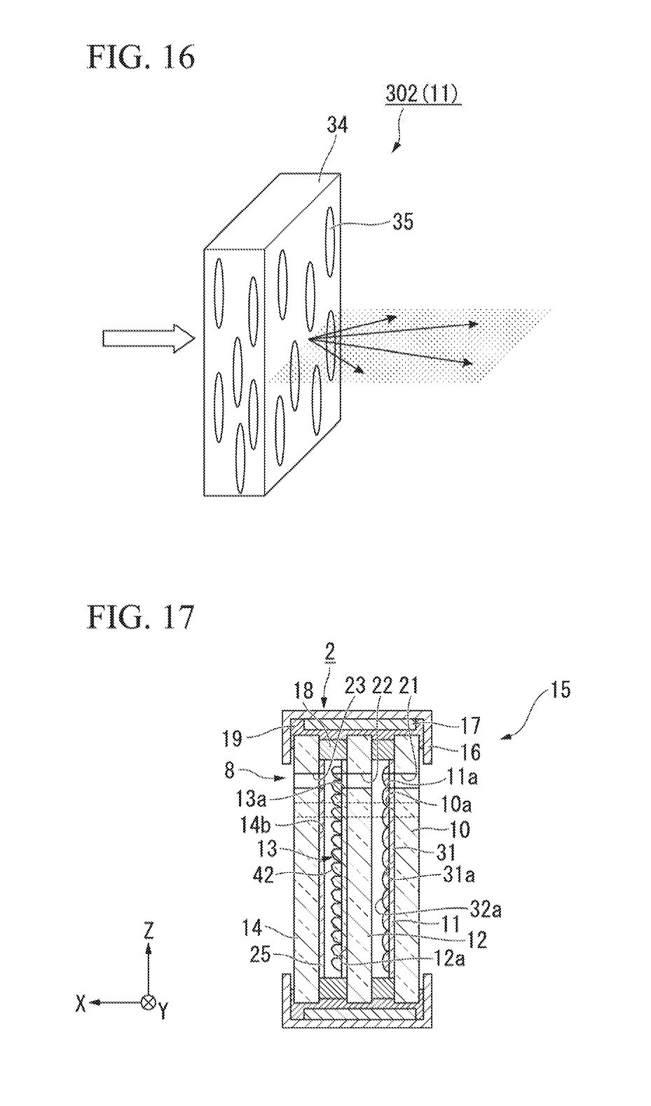

The light-diffusion sheet 11 of the present embodiment has a lenticular lens structure. This is, however, by no means the only possible configuration. Alternatively, the light-diffusion sheet 11 may be, apart from the one having the lenticular structure described above, for example, an anisotropic light-diffusion sheet 302 including a particle-dispersed film as shown in FIG. 16. The particle-dispersed film has a structure in which fibrous or ellipsoidal light-diffusion particles 35 are dispersed in a light-transmitting resin layer 34 serving as a medium in such a manner that the particles 35 become aligned in the vertical direction (Z direction). This particle-dispersed film have such properties as to diffuse light significantly primarily in the left/right directions and slightly in the up/down directions.

In addition, the daylighting device 2 may be configured to include, for example, functional members 25 such as a light-transmitting thermal insulation film (thermal insulation member) that blocks radiant heat from natural light (sunlight), an IR-reflecting film that reflects infrared light (IR), a design sheet, and a light-incidence-angle-controlling member.

FIG. 17 is a diagram showing an exemplary daylighting member including functional members.

As shown in FIG. 17, for example, the functional members 25 are provided on the light-entering side of the daylighting sheet 13 and on a second face 14b of the third glass plate 14 (which faces the daylighting sheet 13). An incidence-angle-controlling member, which is one of the functional members 25, changes the angle of incidence of light on the daylighting sheet 13 which has good daylighting properties for arbitrary solar altitudes (angles of incidence). The provision of the incidence-angle-controlling member, even if the daylighting device 2 is installed at a different location or in a different orientation, enables correction for changes of incident light having shifted overall so that the light having been subjected to this correction is incident to the daylighting sections 42. The provision hence makes it possible to maintain good daylighting properties for arbitrary solar altitudes.

The daylighting device 2 includes three glass plates in the present embodiment. This is, however, by no means the only possible configuration.

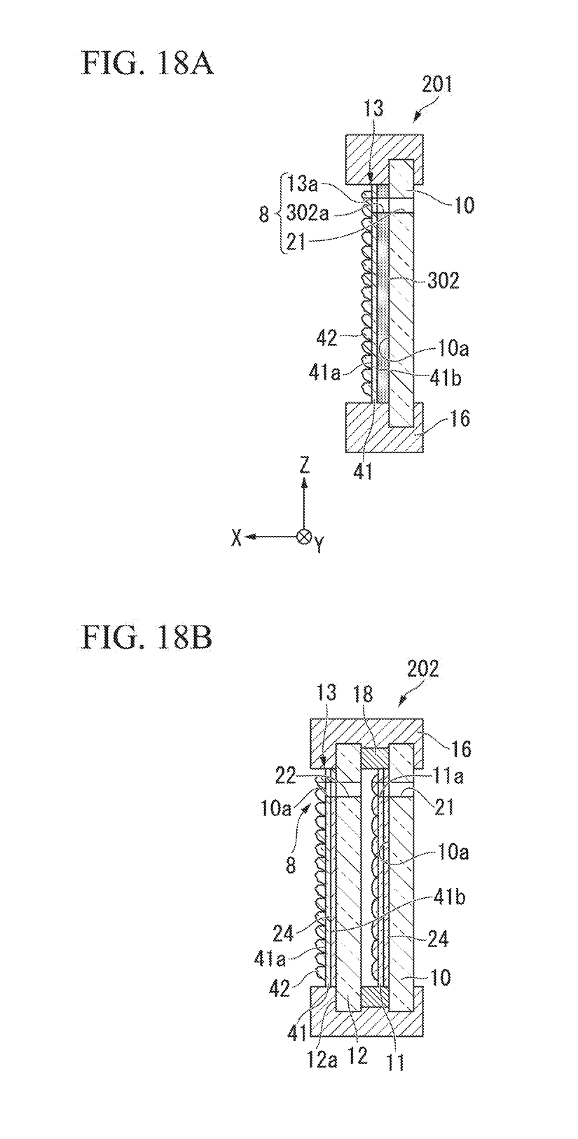

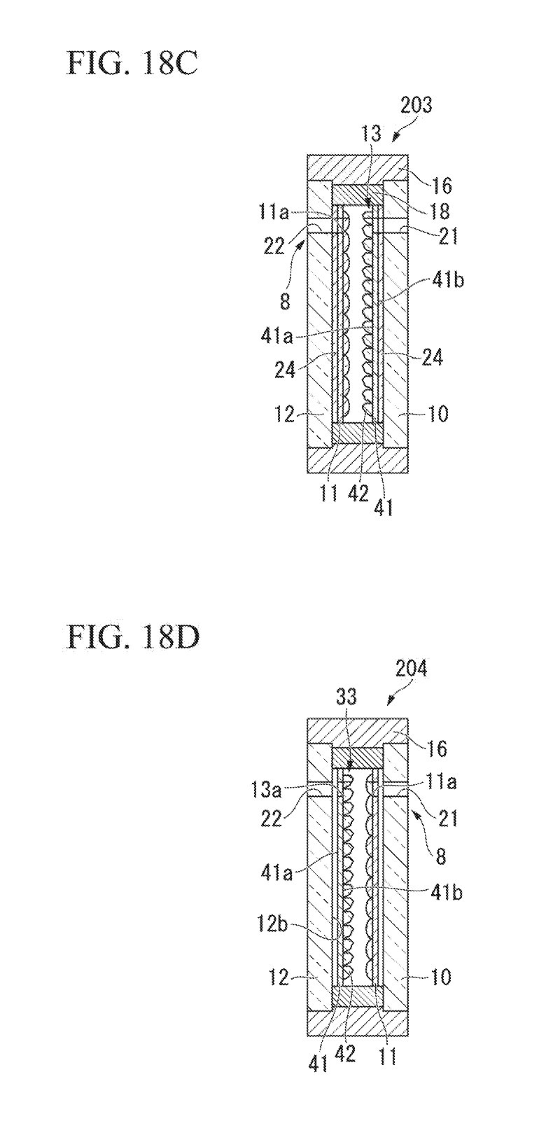

FIGS. 18A to 18D are diagrams showing other exemplary structures for the daylighting device. In these figures, sunlight enters the daylighting device from the left side of the paper.

A daylighting device 201 shown in FIG. 18A has a single-glass-plate structure and includes a first glass plate 10, an anisotropic light-diffusion sheet (adhesive layer) 302, a daylighting sheet 13, and a frame 16. The daylighting sheet 13 and the anisotropic light-diffusion sheet 302 are provided on a first face 10a of the single first glass plate 10, and all these members are held together by the frame 16. The anisotropic light-diffusion sheet 302 in this example is adhesive. The daylighting sheet 13 is attached to the first glass plate 10 via the anisotropic light-diffusion sheet 302. Each ventilation hole 8 includes a plurality of through holes 13a, 302a, and 21 extending respectively through the daylighting sheet 13, the anisotropic light-diffusion sheet 302, and the first glass plate 10.

A daylighting device 202 shown in FIG. 18B has a double-glass-plate structure and includes a first glass plate (transparent substrate) 10 including a light-diffusion sheet 11 on a first face 10a thereof and a second glass plate (transparent substrate) 12 including a daylighting sheet 13 on a first face 12a thereof. The first and second glass plates 10 and 12 are attached together via an adhesive (affixing member) 18 and held inside a frame 16. The daylighting sheet 13 and the light-diffusion sheet 11 are attached respectively to the glass plates 10 and 12 via an adhesive layer 24. Each ventilation hole 8 includes a plurality of through holes formed respectively in the daylighting sheet 13, the second glass plate 12, the light-diffusion sheet 11, and the first glass plate 10.

A daylighting device 203 shown in FIG. 18C is the same as the daylighting device 202 shown in FIG. 18B in that both have a double-glass-plate structure, but differs in that the light-diffusion sheet 11 is provided on a light-entering side of the daylighting sheet 13. The relative positions of the daylighting sheet 13 and the light-diffusion sheet 11 may be reversed in this manner. In this daylighting device 203, the first glass plate 10 and the second glass plate 12 are arranged so that the daylighting sheet 13 and the light-diffusion sheet 11 face each other.

A daylighting device 204 shown in FIG. 18D differs from the daylighting devices 201 and 202 shown in FIGS. 18A and 18B in that the daylighting sheet 33 and the light-diffusion sheet 11 are provided independently between two glass plates.

The daylighting sheet 33 and the light-diffusion sheet 11 are provided between the first glass plate 10 and the second glass plate 12 at a distance from the first and second glass plates 10 and 12. There is a gap between the daylighting sheet 33 and the light-diffusion sheet 11 which are individually arranged in a light-transmitting direction and held inside a frame 16. The light-diffusion sheet 11 is disposed on the light-exiting side of the daylighting sheet 33 in this example. Alternatively, the light-diffusion sheet 11 may be disposed on the light-entering side of the daylighting sheet 33. Each ventilation hole 8 includes through holes 21, 11a, 13a, and 22 extending respectively through the first glass plate 10, the light-diffusion sheet 11, the second glass plate 12, and the daylighting sheet 33. The through hole 21 in the first glass plate 10 and the through hole 22 in the second glass plate 12 correspond to a third through hole of the present invention.

Additionally, the daylighting sheet 33 shown in FIG. 18D includes a plurality of daylighting sections 42 on a second face 4 lb of a film base member 41. The daylighting sheet 13 described earlier includes the plurality of daylighting sections 42 on the first face 41a of the film base member 41 which faces the window. In this example, however, the plurality of daylighting sections 42 are provided on the indoor side of the film base member 41. The daylighting sheet 33 is disposed in such an orientation that the first face 41a of the film base member 41 faces the second face 12b of the second glass plate 12. The daylighting sections 42 may be orientated to face the interior in this manner.

### Second Embodiment

Next will be described the structure of a daylighting device in accordance with a second embodiment of the present invention.

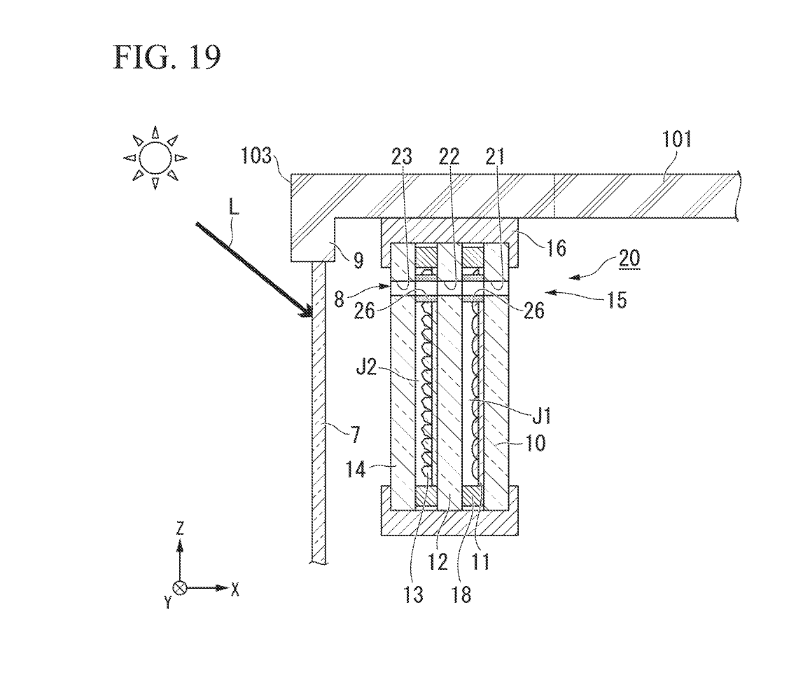

FIG. 19 is a schematic cross-sectional view of the structure of the daylighting device of the second embodiment.

A daylighting device 20 of the present embodiment has a basic structure that is substantially the same as that of the daylighting device of the first embodiment, but differs in that the gaps between glass plates in which through holes are formed are sealed. The following description will elaborate on differences and skip over common features.

As shown in FIG. 19, in the daylighting device 20, there are provided sealing members 26, one between the first glass plate 10 and the second glass plate 12 and another between the second glass plate 12 and the third glass plate 14, so as to constitute a part of each ventilation hole 8. The ventilation hole 8 includes a through hole 21 in the first glass plate 10, a through hole 22 in the second glass plate 12, a through hole 23 in the third glass plate 14, and the pair of sealing members 26, to constitute a single communication hole.

The sealing members 26 are made from an adhesive material and combine the glass plates 10, 12, and 14. The sealing members 26 may be made from a material similar to the adhesive 18 provided on the peripheries of the glass plates 10, 12, and 14.

In the present embodiment, a sealed space J1 is formed between the first glass plate 10 and the second glass plate 12 in such a manner as to be surrounded by these glass plates 10 and 12, sealing members 26, and adhesive 18. A sealed space J2 is also formed between the second glass plate 12 and the third glass plate 14 in such a manner as to be surrounded by these glass plates 12 and 14, sealing members 26, and adhesive 18.

The structure of the present embodiment, similarly to the previous embodiment, can prevent thermal cracking of the multilayered glass 7 and the daylighting unit 15. Furthermore, the provision of the sealing members 26 between the glass plates can prevent dust, waste, and other unwanted material from moving into the gaps between the glass plates 10, 12, and 14 through the ventilation holes (communication holes) 8. If there were dust, waste, or other unwanted material sticking to the surfaces of the daylighting sheet 13 and the light-diffusion sheet 11, the optical functions of the daylighting sheet 13 and the light-diffusion sheet 11 could be degraded. In the present embodiment, however, dust, waste, and other unwanted material are prevented from sticking to the surfaces of the daylighting sheet 13 and the light-diffusion sheet 11, by the structure that does not allow exposure of the surfaces of the daylighting sheet 13 and the light-diffusion sheet 11 to open air. Therefore, stable optical functions can be maintained over an extended period of time. This structure also increases maintainability of the daylighting sheet 13 and the light-diffusion sheet 11.

In addition, the sealing members 26, provided between the glass plates 10, 12, and 14 and having a sufficient thickness, can maintain the distances separating the glass plates 10, 12, and 14.

### Third Embodiment

Next will be described the structure of a daylighting device in accordance with a third embodiment of the present invention.

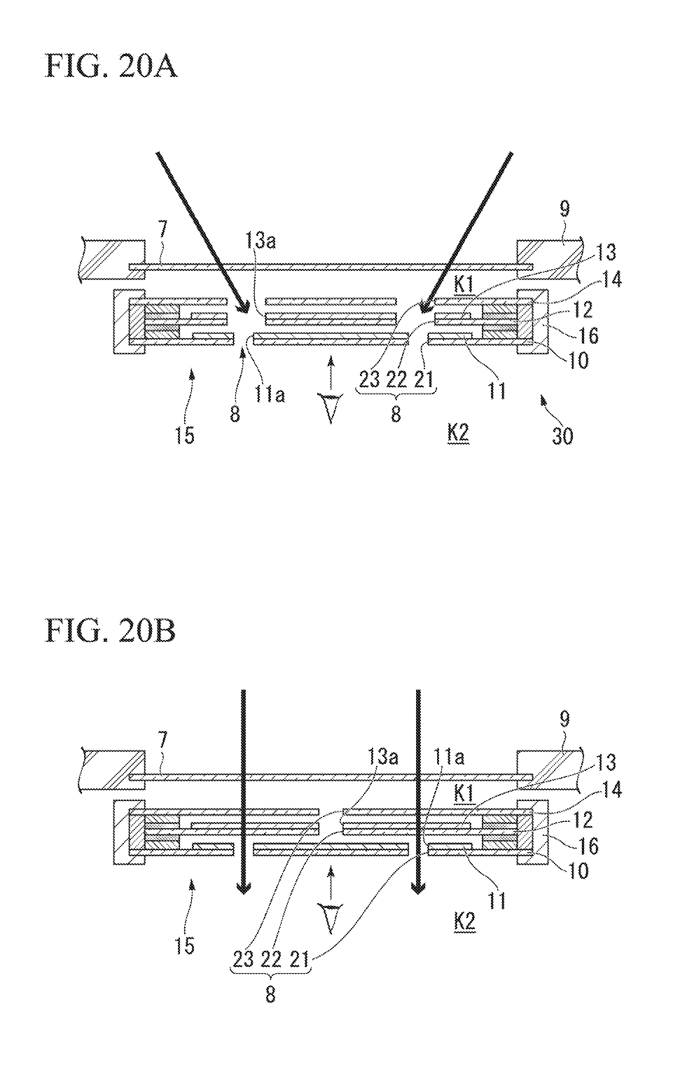

FIG. 20A is a schematic cross-sectional view of the structure of the daylighting device of the third embodiment. FIG. 20A is a cross-sectional view of the daylighting device as viewed from a ceiling end thereof.

A daylighting device 30 of the present embodiment has a basic structure that is substantially the same as that of the daylighting device of the first embodiment, but differs in that the through hole(s) formed in one/some of the glass plates has/have a different size from the size of the through holes formed in the other glass plates. The following description will elaborate on differences and skip over common features.

As shown in FIG. 20A, in the daylighting device 30, the through hole 21 in the first glass plate 10 having the light-diffusion sheet 11 thereon is smaller in size than the through holes 22 and 23 formed in other glass plates 12 and 14 in the cross-sectional view of the daylighting unit 15.

The through hole 13a formed in the daylighting sheet 13 has the same size and shape as the through hole 22. The through hole 11a formed in the light-diffusion sheet 11 has the same size and shape as the through hole 21. The following description will elaborate on the through holes 21, 22, and 23 in the glass plates 10, 12, and 14. The centers of the through holes 21, 22, and 23, constituting the ventilation hole 8, are aligned also in the present embodiment.

The daylighting device 30 of the present embodiment, similarly to those of the previous embodiments, can prevent thermal cracking of the multilayered glass 7 and the daylighting unit 15. Furthermore, in the present embodiment, since the through hole 21, located closest to the interior, has the smallest size, the light exiting the daylighting sheet 13 is unlikely to pass through the through hole 21 and produce glare without being obstructed. In other words, most light exiting the daylighting sheet 13 passes through the light-diffusion sheet 11, which can diffuse the light that would otherwise produce glare and hence prevent occupants from feeling glare.

FIG. 20B is a cross-sectional view of a daylighting device in which the position(s) of the center(s) of one/some of the through holes is/are different, as the daylighting device is viewed from a ceiling end thereof.

In FIG. 20B, the through hole 21 formed in the first glass plate 10 having the light-diffusion sheet 11 thereon is provided completely out of alignment with the through holes 22 and 23 formed in the other, second glass plate 12 and third glass plate 14. In other words, the daylighting sheet 13 is visible through the through hole 21 in the first glass plate 10. The light exiting the daylighting sheet 13 may therefore be emitted to the interior through the through hole 21 without being obstructed. This light will cause glare, which is undesirable. In addition, air flow is disrupted, and ventilation efficiency decreases because the ventilation hole 8 does not constitute a single continuous communication hole.

In contrast to this, in the daylighting device 30 of the present embodiment shown in FIG. 20A, the through holes 21, 22, and 23 having aligned centers constitute each single ventilation hole 8. Therefore, even when one/some of the through holes (through hole 21) is/are smaller in size, air flow is not disrupted, and ventilation efficiency does not decrease between the space K1 (located on the multilayered glass 7 side) and the indoor-side space K2 separated by the daylighting device 30 from the space K1.

Now will be described approximately how much smaller in size the through hole 21 on the light-diffusion sheet 11 side needs to be than the through hole 22 on the daylighting sheet 13 side.

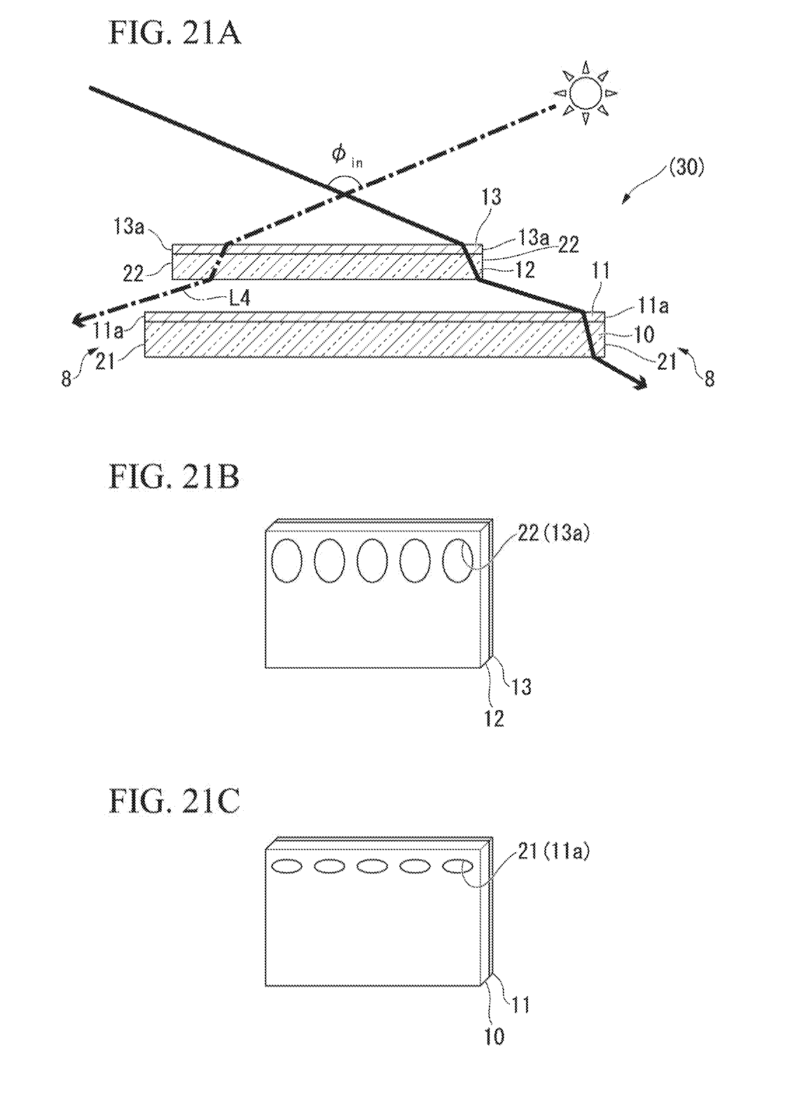

FIG. 21A is a cross-sectional view of optical paths through which incident light is transmitted when sunlight has a large azimuth, as the daylighting device is viewed from a ceiling end thereof. FIG. 21B is a perspective view of through holes formed in a daylighting sheet. FIG. 21C is a perspective view of through holes formed in a light-diffusion sheet.

As shown in FIG. 21A, sunlight is incident to the daylighting device 30 at varying azimuths over the year. Therefore, as shown in FIGS. 21B and 21C, even when the through hole 21 in the first glass plate 10 having the light-diffusion sheet 11 thereon is smaller in size than the through hole 22 in the second glass plate 12 having the daylighting sheet 13 thereon, if the solar azimuth Φᵢₙ is large, as shown in FIG. 21A, light L4 exiting the daylighting sheet 13 may reach the interior through the through hole 21 without passing through the light-diffusion sheet 11 or otherwise being obstructed.

Therefore, the daylighting sheet 13 is preferably not visually recognizable to an occupant so that the light exiting the daylighting sheet 13 enters the light-diffusion sheet 11 as much as possible. In other words, the through holes 21 on the light-diffusion sheet 11 side are formed in such a small size, relative to the size of the through holes 22 on the daylighting sheet 13 side, that the daylighting sheet 13 is not visible through the through holes 21 to an occupant no matter where the occupant is in the interior. This configuration can further prevent the light exiting the daylighting sheet 13 from being guided directly into the interior.

### Fourth Embodiment

Next will be described a daylighting device in accordance with a fourth embodiment of the present invention.

The daylighting device of the present embodiment described below has a basic structure that is substantially the same as that of the daylighting device of the first embodiment, but differs in that the ventilation holes has an inner face made of a material having light-blocking properties. The following description will elaborate on differences from the structure of the first embodiment and skip over common features. In addition, in the figures used in the description, those elements that are the same as those in any of the previous embodiments are given the same reference signs.

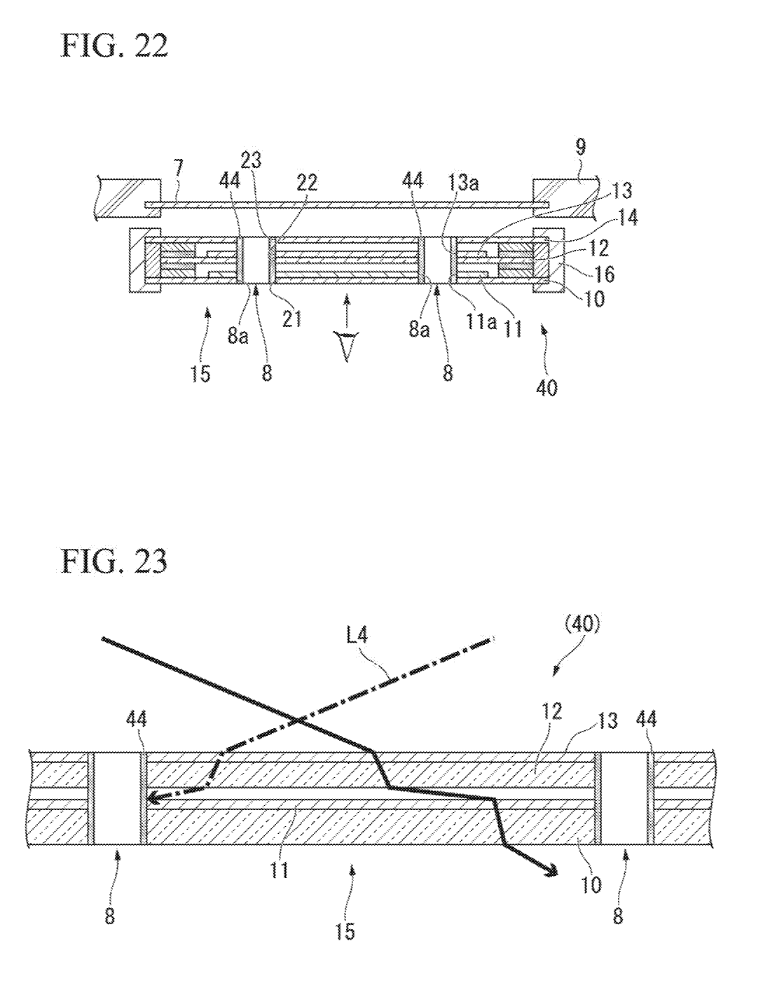

FIG. 22 is a cross-sectional view of the overall structure of the daylighting device of the fourth embodiment.

As shown in FIG. 22, a daylighting device 40 is characterized in that the ventilation holes 8 formed in the daylighting unit 15 each have an inner face 8a on which there is provided a light-blocking member 44.

The light-blocking member 44 is provided to cover the inner faces of the through holes 22 and 11a formed in the first glass plate 10 and the light-diffusion sheet 11, the through holes 22 and 13a formed in the second glass plate 12 and the daylighting sheet 13, and the through holes 23 formed in the third glass plate 14, the through holes 22, 11a, 22, 13a, and 23 constituting the ventilation holes 8, and to fill in the gaps between, and join, the glass plates 10, 12, and 14 together. In this manner, the ventilation holes 8 are formed that are continuous throughout the glass plates 10, 12, and 14.

The light-blocking member 44 may be, for example, a caulking material having light-blocking properties. This is by no means the only possible configuration. Alternatively, the light-blocking member 44 may be a light-blocking cover capable of covering gaps between the glass plates 10, 12, and 14.

FIG. 23 is a cross-sectional view of optical paths through which incident light is transmitted when sunlight has a large azimuth, as the daylighting device is viewed from a ceiling end thereof.

As shown in FIG. 23, sunlight is incident to the daylighting device 40 at varying azimuths over the year. As mentioned in the third embodiment, the light exiting the daylighting sheet 13 may therefore be guided to the interior through the ventilation holes 8 without passing through the light-diffusion sheet 11 or otherwise being obstructed.

In the present embodiment, the light L4, which is part of the light exiting the daylighting sheet 13, but which is not incident to the light-diffusion sheet 11, is blocked by the light-blocking member 44. Therefore, useless glare can be suppressed that directly enters the eye of an occupant.

In the present embodiment, each ventilation hole 8 in the daylighting unit 15 has the light-blocking member 44. This is by no means the only possible configuration. Alternatively, for example, some of the ventilation holes 8 may have the light-blocking member 44, and the other ventilation holes 8 have no light-blocking member 44.

### Fifth Embodiment

Next will be described a daylighting device in accordance with a fifth embodiment of the present invention.

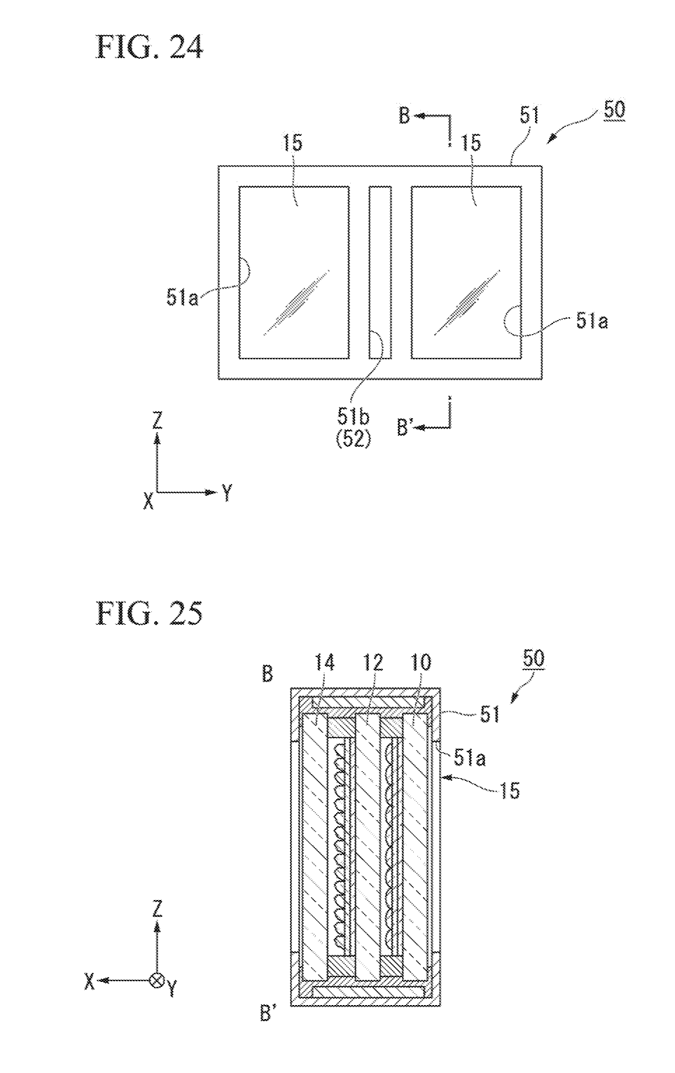

FIG. 24 is a front view of the overall structure of the daylighting device of the fifth embodiment. FIG. 25 is a schematic cross-sectional view of the structure of the daylighting device of the fifth embodiment taken along line B-B′ in FIG. 24.

The daylighting device of the present embodiment described below has a basic structure that is substantially the same as that of the daylighting device of the first embodiment, but differs in that there are provided a plurality of daylighting units in a single frame. The following description will elaborate on differences from the structure of the first embodiment and skip over common features. In addition, in the figures used in the description, those elements that are the same as those in any of the previous embodiments are given the same reference signs.

As shown in FIGS. 24 and 25, a daylighting device 50 of the present embodiment includes: a frame 51 having a plurality of openings; and two daylighting units 15 of the same size. The daylighting units 15 may be any of the daylighting units of the abovementioned embodiments.

The frame 51 is a frame body, rectangular in a plan view, having two large openings 51a and a small opening 51b provided between the large openings 51a. Each large opening 51a contains a different one of the daylighting units 15. Meanwhile, the small opening 51b contains no daylighting unit 15 and serves as an air hole 52.

The daylighting device 50 is disposed so that the frame 51 has a length thereof (Y direction) in the left/right direction of the window.

In this configuration, one of the daylighting units 15 is located in the left side of the window, and the other daylighting unit 15 is located in the right side of the window. An air hole (ventilation hole) 52 that extends in the up/down direction is provided at the center of the window.

The daylighting device 50 of the present embodiment is applicable to large-sized windows because the plurality of daylighting units 15 are contained in the single frame 51. Each daylighting unit 15 has numerous ventilation holes 8. Ventilation efficiency however needs to be further increased if the daylighting device 50 is installed on a large-sized window. In the present embodiment, the air hole 52 is provided between the pair of daylighting units 15, the frame 51 separating the air hole 52 from the pair of daylighting units 15. Therefore, even if the daylighting device 50 is installed on a large-sized window, ventilation efficiency is further increased between the window-side space and the indoor-side space separated by the daylighting device 50, and thermal cracking and other damage can be prevented in the multilayered glass and the glass plates 10, 12, and 14 in the daylighting device 50.

The following will describe variation examples of the daylighting device of the present embodiment.

### First Variation Example of Daylighting Device

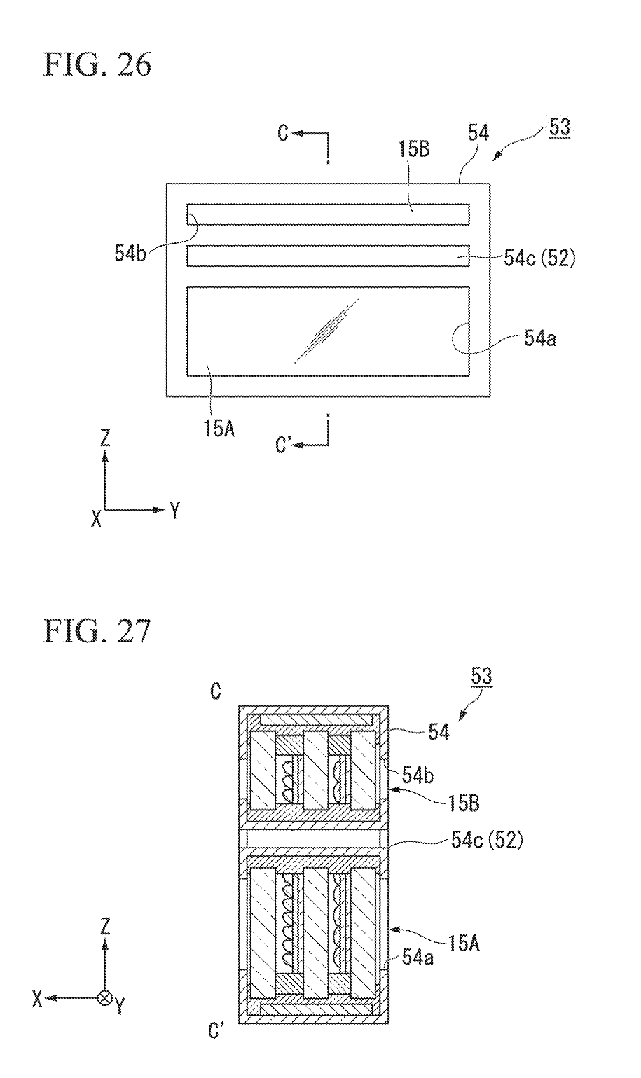

FIG. 26 is a front view of a first variation example of the daylighting device of the fifth embodiment. FIG. 27 is a cross-sectional view of the daylighting device shown in FIG. 26 taken along line C-C′.

Referring to FIGS. 26 and 27, a daylighting device 53 of the first variation example includes: a frame 54 having a plurality of openings; and two daylighting units 15A and 15B of different sizes.

The frame 54 has a first opening 54a, a second opening 54b, and a third opening 54c each having a different opening area. These first opening 54a, second opening 54b, and third opening 54c are arranged in the up/down direction (Z direction) of the frame 54 as viewed in reference to the orientation of the installed daylighting device 53.

Specifically, the first opening 54a, having the largest opening area, is located in the bottom portion of the frame 54 and contains the daylighting unit 15A therein. The second opening 54b, having a smaller opening area than the first opening 54a, is located in the top portion of the frame 54 and contains the daylighting unit 15B therein. The third opening 54c, having a smaller opening area than the second opening 54b, is located at the center of the frame 54 between the first opening 54a and the second opening 54b. This third opening 54c contains no daylighting unit 15 and serves as the air hole 52.

In the structure of the present embodiment, the warm air collecting in the ceiling end can be likewise efficiently discharged indoors through the air hole 52 located higher than the center of the daylighting device 53.

### Second Variation Example of Daylighting Device

A structure in which a single frame contains a plurality of daylighting units was described above. This is by no means the only possible structure. Alternatively, as an example, a single frame may contain one daylighting unit and one air hole.

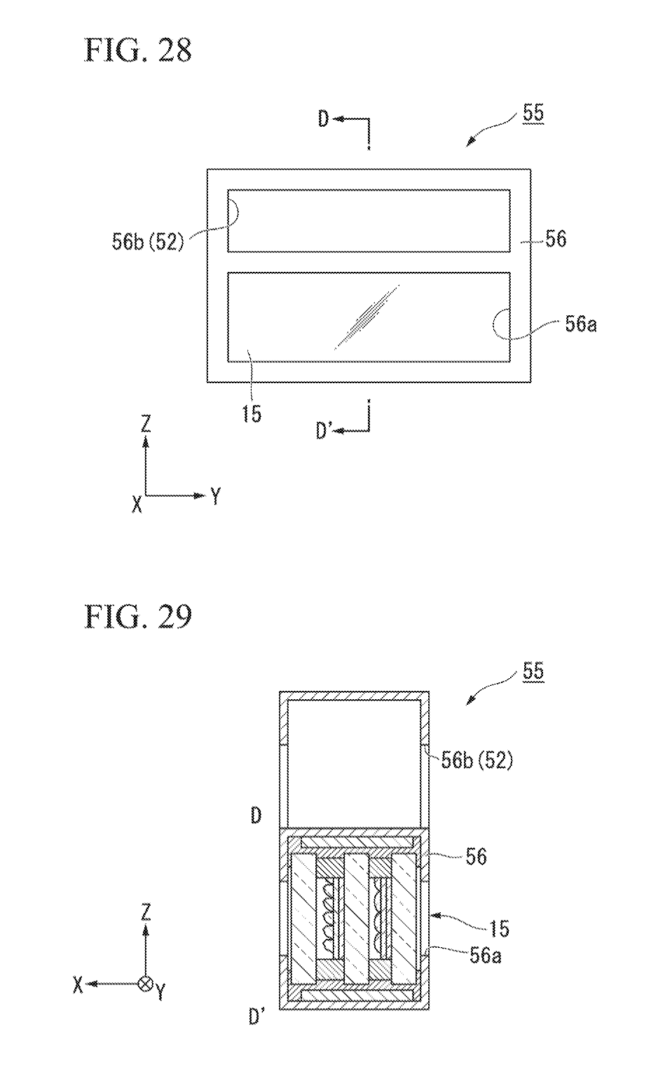

FIG. 28 is a front view of a second variation example of the daylighting device of the fifth embodiment. FIG. 29 is a cross-sectional view of the daylighting device shown in FIG. 28 taken along line D-D′.

Referring to FIGS. 28 and 29, for example, a daylighting device 55 of the second variation example includes: a frame 56 having a first opening 56a and a second opening 56b; and a single daylighting unit 15.

The first opening 56a and the second opening 56b are arranged in the up/down direction (Z direction) of the frame 56 as viewed in reference to the orientation of the installed daylighting device 55. The first opening 56a located in the lower portion of the frame 56 contains the daylighting unit 15. In contrast, the second opening 56b located in the upper portion of the frame 56 contains no daylighting unit 15 and serves as the air hole 52.

In the present embodiment, the warm air collecting in the ceiling end can be likewise efficiently discharged indoors through the air hole 52 located in the upper portion of the daylighting device 55.

### Sixth Embodiment

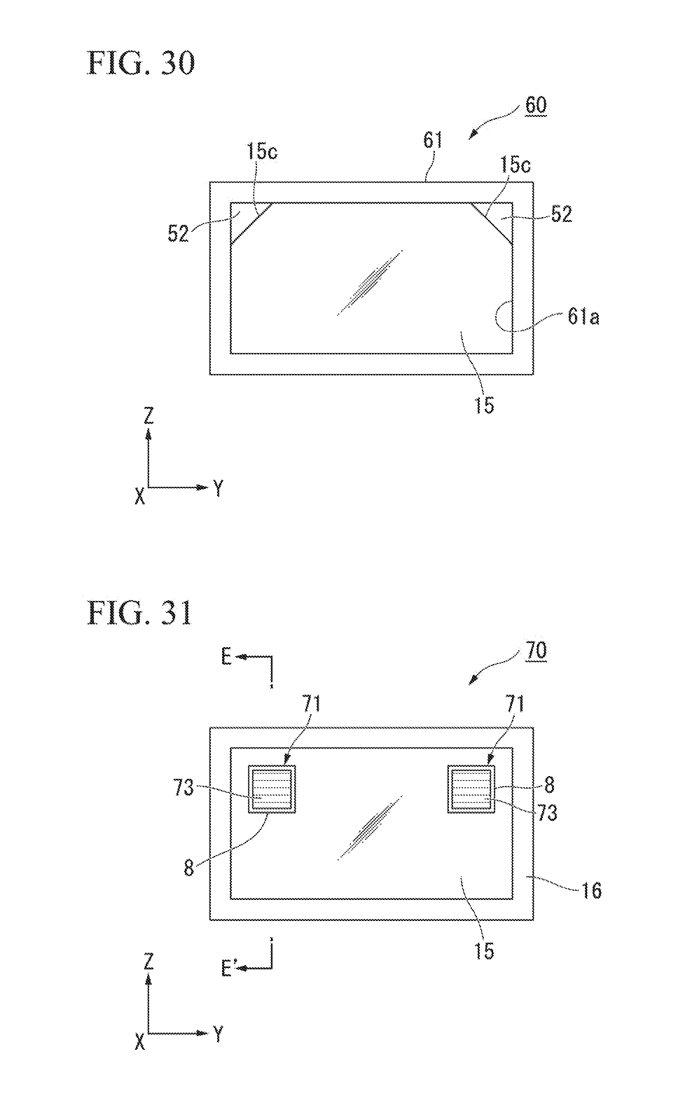

Next will be described a daylighting device of a sixth embodiment of the present invention. FIG. 30 is a front view of the overall structure the daylighting device of the sixth embodiment.

The daylighting device of the present embodiment described below has a basic structure that is substantially the same as that of the daylighting device of the first embodiment, but differs in the external shape of the daylighting unit and the shape of the opening of the frame. The following description will elaborate on differences from the structure of the first embodiment and skip over common features. In addition, in the figures used in the description, those elements that are the same as those in any of the previous embodiments are given the same reference signs.

Referring to FIG. 30, a daylighting device 60 of the present embodiment includes: a rectangular frame 61 having a single opening 61a; and a daylighting unit 15 contained in the opening 61a of the frame 61. In the present embodiment, the daylighting unit 15 may likewise be any of the daylighting units of the abovementioned embodiments.

The daylighting unit 15 of the present embodiment does not have a rectangular planar shape when viewed normal to the daylighting unit 15. Two of the four corners of the daylighting unit 15 have notches 15c and 15c. Therefore, air holes 52 and 52 formed by notches 15c and 15c are located between the frame 61 and the daylighting unit 15.

The air holes 52 and 52 are located in the upper portion of the frame 61 as viewed in reference to the orientation of the installed daylighting device 60. When viewed from the interior, one of the air holes 52 is in the right side of the multilayered glass, and the other air hole 52 is in the left side of the multilayered glass. This configuration enables ventilation between the window-side space and the indoor-side space separated by the daylighting device 60 without compromising on daylighting function even in seasons and time periods when the solar azimuth is large.

### Seventh Embodiment

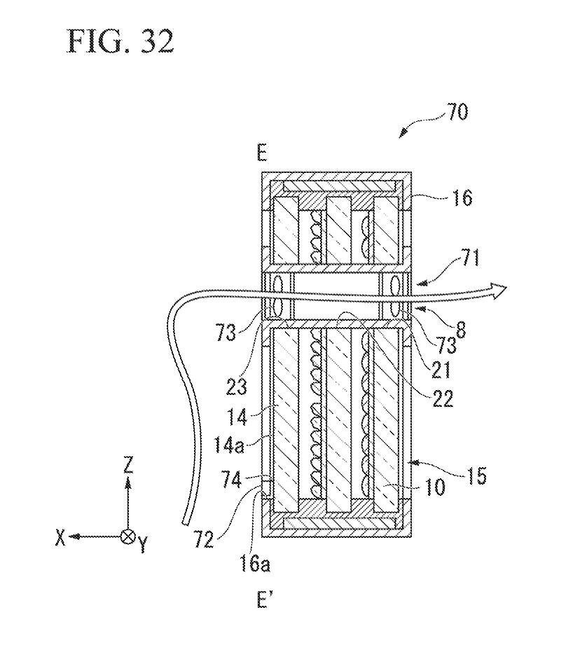

Next will describe a seventh embodiment of the present invention. FIG. 31 is a front view of the overall structure of a daylighting device of the seventh embodiment. FIG. 32 is a cross-sectional view of the daylighting device shown in FIG. 31 taken along line E-E′.

The daylighting device of the present embodiment described below has a basic structure that is substantially the same as that of the daylighting device of the first embodiment, but differs in that there are provided fan units. The following description will elaborate on differences from the structure of the first embodiment and skip over common features. In addition, in the figures used in the description, those elements that are the same as those in any of the previous embodiments are given the same reference signs.

Referring to FIGS. 31 and 32, a daylighting device 70 of the present embodiment includes: a daylighting unit 15; a frame 16 holding the daylighting unit 15; a plurality of fan units 71; and solar cells 72.

The daylighting unit 15 has a pair of ventilation holes 8. In each ventilation hole 8 is there disposed a different one of the fan units 71 each composed of two exhaust fans 73. The ventilation hole 8 has an inner face thereof on which there is provided a light-blocking member 44 described above. In the present embodiment, the daylighting unit 15 may likewise be any of the daylighting units of the abovementioned embodiments.

One of the two exhaust fans 73 and 73 in the fan units 71 is disposed inside the through hole 21 in the first glass plate 10, and the other exhaust fan 73 is disposed inside the through hole 23 in the third glass plate 14.

The solar cells 72 are fixed on an open face 16a via, for example, an adhesion material 74. The open face 16a is open in a part of the second face 14b of the third glass plate 14 located closest to the light-entering face of the daylighting unit 15 and is located in the lower portion of the frame 16. The solar cells 72 receive sunlight and generate electric power to drive the exhaust fans 73.

Since the fan units 71 are disposed in the ventilation holes 8 in the daylighting unit 15, the daylighting device 70 of the present embodiment is capable of forcibly ejecting the air between the multilayered glass and the daylighting device 70 to the interior.

The window glass, the daylighting device 70, and the space between the window glass and the daylighting device 70 are especially heated in the time periods when sunlight shines on the daylighting device 70. Therefore, the exhaust fans 73 only need to be driven during daytime while sunlight is shining on the daylighting device 70. Accordingly, the present embodiment is configured so that the solar cells 72 generate electric power on which the exhaust fans 73 are driven.

In this configuration, the exhaust fans 73 are driven by the solar cells only in the time periods when there is sunlight irradiation and automatically stopped after sunset. The exhaust fans 73 are automatically driven and stopped in this manner, which lowers power consumption. When there is no sunlight shining on the daylighting device 70, such as during night time, the exhaust fans 73 are not driven. This poses no problems because the window glass is not locally heated.

There are provided light-blocking members 44 in the ventilation holes 8 in the present embodiment. Therefore, dust and waste are unlikely to stick to the surfaces of the daylighting sheet 13 and the light-diffusion sheet 11.

Each ventilation hole 8 in the present embodiment contains two exhaust fans 73. Alternatively, each ventilation hole 8 may contain only one exhaust fan 73.

In addition, the present embodiment includes the solar cells 72 as a means to drive the exhaust fans 73. Alternatively, the present embodiment may include another driving means.

The preferred embodiments of the present invention have been so far described in reference to the attached drawings. The present invention is by no means limited to the embodiments and examples described above. The person skilled in the art could obviously conceive variations and modifications within the scope of the claims. The variations and modifications are encompassed in the technical scope of the claims. The embodiments may be combined in a suitable manner.

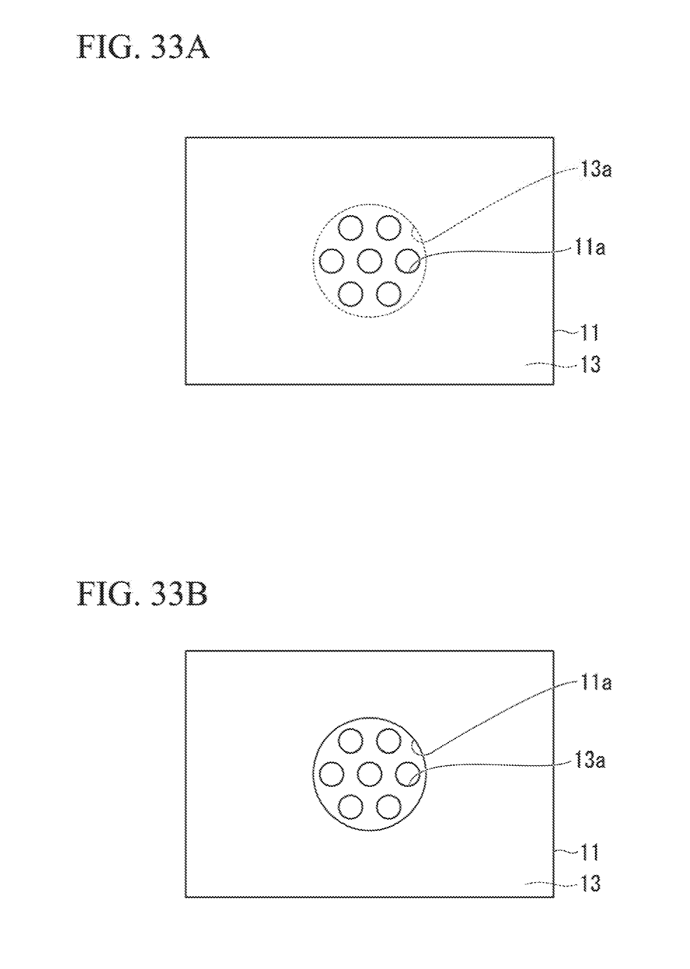

FIGS. 33A and 33B are diagrams showing exemplary structures of a ventilation hole.

In the previous embodiments, the ventilation hole is composed of a plurality of through holes each formed in a different member. Alternatively, one/some of the members may have a plurality of through holes formed therein.

For example, as shown in FIG. 33A, the daylighting sheet 13 may have a single through hole 13a formed therein, whereas the light-diffusion sheet 11 may have a plurality of through holes 11a formed therein. The through holes 11a each have a smaller diameter than the diameter of the through hole 13a. In this example, the plurality of through holes 11a are formed so that almost all of them overlap the through hole 13a when viewed normal to the daylighting sheet 13 and the light-diffusion sheet 11.

Conversely, as shown in FIG. 33B, the daylighting sheet 13 may have a plurality of through holes 13a, whereas the light-diffusion sheet 11 may have a single through hole 11a.

The multilayered glass 7 is not necessarily transparent and may be, for example, wire-reinforced glass or multilayered glass.

### Lighting-Modulation System

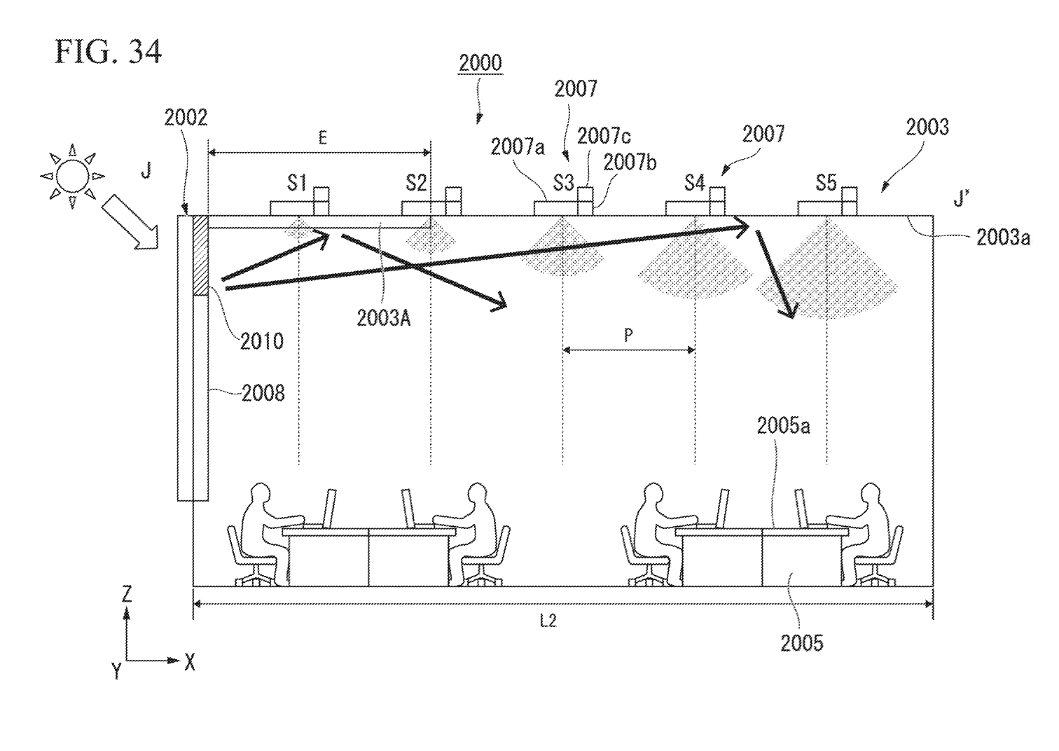

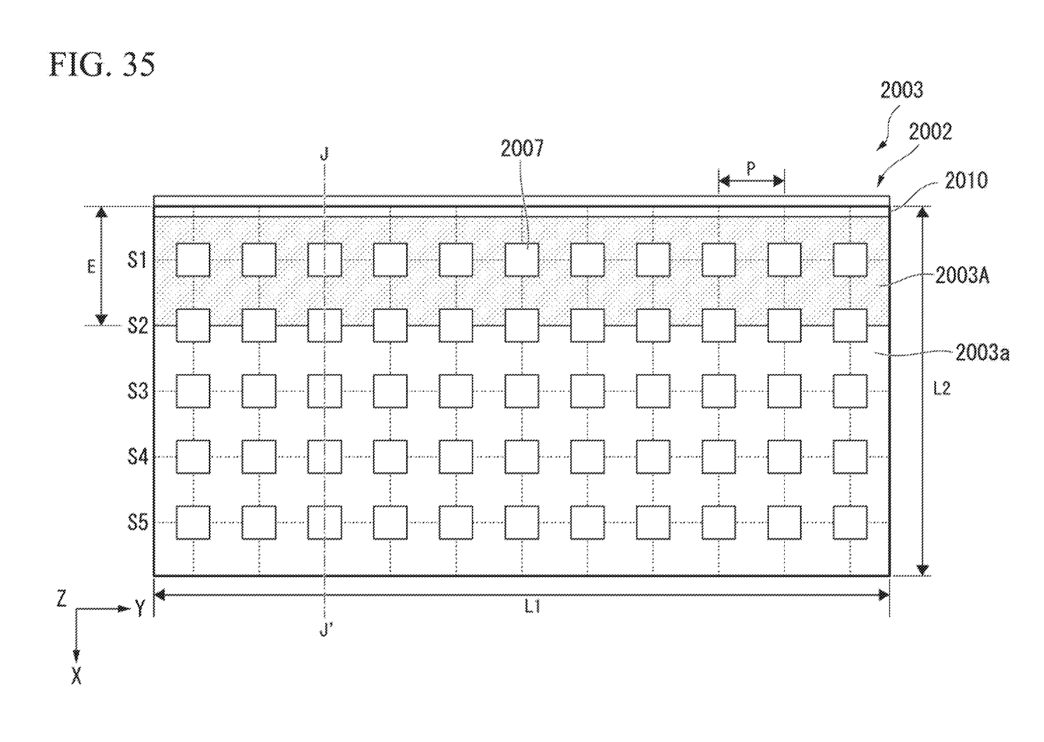

FIG. 34 is a cross-sectional view, taken along line J-J′ in FIG. 35, of a room model 2000 in which a daylighting device and a lighting-modulation system are installed. FIG. 35 is a plan view of a ceiling of the room model 2000.

In the room model 2000, a room 2003 into which external light is guided has a ceiling 2003a constituted partly by a ceiling material that may have high light-reflecting properties. Referring to FIGS. 34 and 35, the ceiling 2003a of the room 2003 is provided with a light-reflecting ceiling material 2003A as the ceiling material having such light-reflecting properties. The light-reflecting ceiling material 2003A is for facilitating the guiding of external light from a daylighting device 2010 installed on a window 2002 deep into the interior. The light-reflecting ceiling material 2003A is disposed on a part of the ceiling 2003a that is close to the window, specifically, on a predetermined part E of the ceiling 2003a (approximately up to 3 meters from the window 2002).

The light-reflecting ceiling material 2003A, as described above, serves to efficiently direct deep into the interior the external light guided indoors through the window 2002, on which the daylighting device 2010 (any of the daylighting devices of the abovementioned embodiments) is installed. The external light guided toward the indoor ceiling 2003a by the daylighting device 2010 is reflected by the light-reflecting ceiling material 2003A, hence changing direction and illuminating a desk top face 2005a of a desk 2005 placed deep in the interior. Thus, the light-reflecting ceiling material 2003A has an effect that the desk top face 2005a is brightly lit up.

The light-reflecting ceiling material 2003A may be either diffuse reflective or specular reflective. Preferably, the light-reflecting ceiling material 2003A is a suitable mix of these properties to achieve both the effect that the desk top face 2005a of the desk 2005 placed deep in the interior is brightly lit up and the effect that glare, uncomfortable to occupants, is suppressed.

Much of the light guided into the interior by the daylighting device 2010 travels in the direction of the part of the ceiling that is close to the window 2002. Still, the part of the interior that is close to the window 2002 often has sufficient lighting. Therefore, the light that strikes the ceiling near the window (part E) can be partially diverted to a deep part of the interior where lighting is poor compared to the part near the window, by additionally using the light-reflecting ceiling material 2003A described here.

The light-reflecting ceiling material 2003A may be manufactured, for example, by embossing irregularities each of approximately several tens of micrometers on an aluminum or similar metal plate or by vapor-depositing aluminum or a similar metal onto the surface of a resin substrate having formed thereon similar irregularities to form a thin film of the metal. Alternatively, the embossed irregularities may be formed from a curved surface with a higher cycle.

Furthermore, the embossed shape formed on the light-reflecting ceiling material 2003A may be changed as appropriate to control light distribution properties thereof and hence resultant indoor light distribution. For example, if stripes extending deep into the interior are embossed, the light reflected by the light-reflecting ceiling material 2003A is spread to the left and right of the window 2002 (in the directions that intersect the length of the irregularities). When the window 2002 of the room 2003 is limited in size or orientation, these properties of the light-reflecting ceiling material 2003A are useful in diffusing light in horizontal directions and at the same time reflecting the light deep into the room.

The daylighting device 2010 is used as a part of a lighting-modulation system for the room 2003. The lighting-modulation system includes, for example, the daylighting device 2010, a plurality of room lighting devices 2007, an insolation adjustment device 2008 installed on the window, a control system for these devices, the light-reflecting ceiling material 2003A disposed on the ceiling 2003a, and other structural members of the whole room.

The window 2002 of the room 2003 has the daylighting device 2010 installed on the upper portion thereof and the insolation adjustment device 2008 installed on the lower portion thereof. In this example, the insolation adjustment device 2008 is a window shade, which is by no means intended to be limiting to the scope of the invention.

The room lighting devices 2007 are arranged in the room 2003 in a lattice in the left/right direction (Y direction) of the window 2002 and in the depth direction of the room (X direction). These room lighting devices 2007, as well as the daylighting device 2010, constitute an illumination system for the whole room 2003.

Referring to FIGS. 34 and 35 illustrating the office ceiling 2003a, for example, the window 2002 has a length L₁ of 18 meters in the left/right direction (Y direction), and the room 2003 has a length (depth) L₂ of 9 meters in the X direction. The room lighting devices 2007 in this example are arranged in a lattice in the length (Y direction) and depth (X direction) of the ceiling 2003a at intervals P each of 1.8 meters. More specifically, a total of 50 room lighting devices 2007 are arranged in a lattice of 10 lines (Y direction) and 5 (X direction) columns.

Each room lighting device 2007 includes an interior lighting fixture 2007a, a brightness detection unit 2007b, and a control unit 2007c. The brightness detection unit 2007b and the control unit 2007c are integrated into the interior lighting fixture 2007a to form a single structure.

Each room lighting device 2007 may include two or more interior lighting fixtures 2007a and two or more brightness detection units 2007b, with one brightness detection unit 2007b being provided for each interior lighting fixture 2007a. The brightness detection unit 2007b, receiving a reflection off the face illuminated by the interior lighting fixture 2007a, detects illuminance on that face. In this example, the brightness detection unit 2007b detects illuminance on the desk top face 2005a of the desk 2005 placed in the interior.

The control units 2007c, each for a different one of the room lighting devices 2007, are connected to each other. In each room lighting device 2007, the control unit 2007c, connected with the other control units 2007c, performs feedback control to adjust the light output of an LED lamp in the interior lighting fixture 2007a so that the illuminance on the desk top face 2005a detected by the brightness detection unit 2007b is equal to a predetermined target illuminance L0 (e.g., an average illuminance: 750 1×).

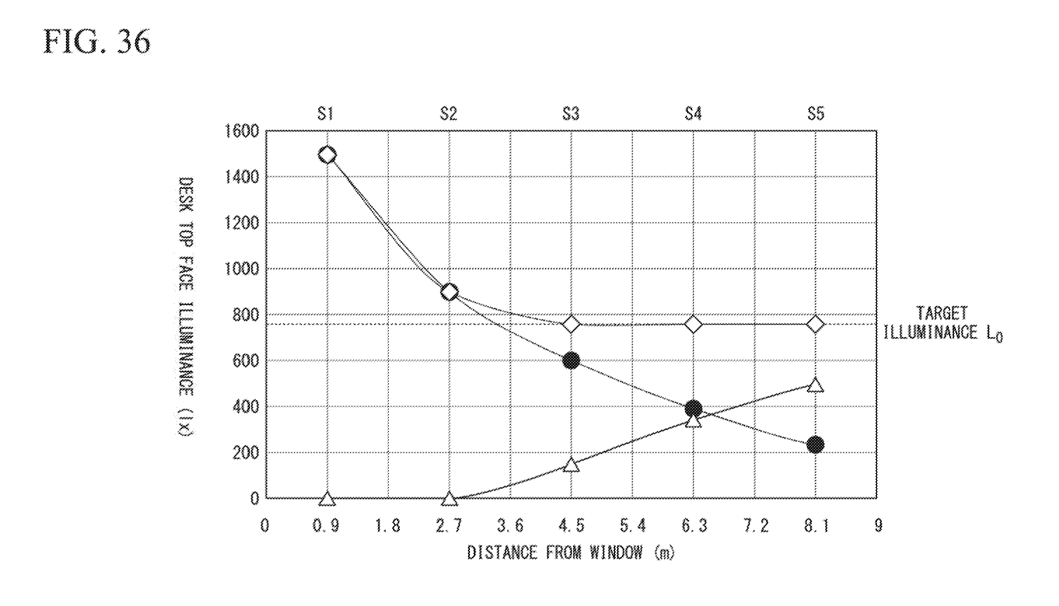

FIG. 36 is a graph representing a relationship between the illuminance produced by the daylighting light (natural light) guided into the interior by the daylighting device and the illuminance produced by the room lighting devices (lighting-modulation system). In FIG. 36, the vertical axis indicates illuminance (1×) on the desk top face, and the horizontal axis indicates distance (meters) from the window. The broken line in the figure indicates the target indoor illuminance. Each black circle denotes an illuminance produced by the daylighting device, each white triangle denotes an illuminance produced by the room lighting devices, and each white diamond denotes a total illuminance.

Referring to FIG. 36, the desk top face illuminance attributable to the daylighting light guided by the daylighting device 2010 is highest at the window and decreases with increasing distance from the window. This illuminance distribution in the depth direction of the room is caused during daytime by natural daylight coming through a window in the room in which the daylighting device 2010 is installed. Accordingly, the daylighting device 2010 is used in combination with the room lighting devices 2007 which enhance the indoor illuminance distribution. Each room lighting device 2007, disposed on the interior ceiling, detects an average illuminance below that device by means of the brightness detection unit 2007b and lights up in a modulated manner so that the desk top face illuminances across the whole room are equal to the predetermined target illuminance L0.

Therefore, a column S1 and a column S2 near the window only dimly light up, whereas a column S3, a column S4, and a column S5 light up to produce output that increases with increasing depth into the room (increases in the order of the column S3, the column S4, and the column S5). Consequently, the desk top faces across the whole room are lit up by the sum of the illumination by natural daylight and the illumination by the room lighting devices 2007 at a desk top face illuminance of 750 1×, which is regarded as sufficient for desk work (see, JIS Z9110, General Rules of Recommended Lighting Levels, Recommended Illuminance at Offices).

As described above, light can be delivered deep into the interior by using both the daylighting device 2010 and the lighting-modulation system (room lighting devices 2007) together. This can in turn further improve indoor brightness and ensure a sufficient desk top face illuminance for desk work across the whole room, hence realizing a more stable, brightly lit-up environment independently from the season or the weather.

### INDUSTRIAL APPLICABILITY

The present invention, in an aspect thereof, is applicable to, for example, a daylighting device that needs to suppress temperature increases between window glass and the daylighting device and hence prevent thermal cracking of the window glass and a substrate of the daylighting device.

### REFERENCE SIGNS LIST

2, 20, 30, 40, 50, 53, 55, 60, 70, 201, 202, 203, 204, and 2010: Daylighting Device
8, 8A, 8B, and 8C: Ventilation Hole (Communication Hole)
8a: Inner Face
11a, 13a, 21, 22, and 23: Through Hole
L: Sunlight
10: First Glass Plate (Transparent Base Member)
11: Light-diffusion Sheet (Light-diffusion Member)
11a: Through Hole (Second Through Hole)
13: Daylighting Sheet (Daylighting Member)
13a: Through Hole (First Through Hole)
16, 51, 54, 56, and 61: Frame
18: Adhesive (Affixing Member)
24: Adhesive Layer
41: Film Base Member (First Base Member)
41a: First Face
41b: Second Face
42: Daylighting Section
42E: Fifth Face (Reflective Face)
42F: Sixth Face (Reflective Face)
52: Air Hole (Ventilation Hole)
61a: Opening
73: Exhaust Fan
K1 and K2: Space
302: Anisotropic Light-diffusion Sheet (Adhesive Layer)

1. A daylighting device, comprising:
a daylighting member comprising: a first base member having light-transmitting properties; and a plurality of protruding daylighting sections having light-transmitting properties and provided on a first face or a second face of the first base member; and
a ventilation hole configured to enable a space on the first face to communicate with a space on the second face opposite from the first face.

2. The daylighting device according to claim 1, wherein the ventilation hole is provided in a region where the daylighting member makes no contribution to daylighting.

3. The daylighting device according to claim 1, wherein:
the daylighting member has a first through hole extending through a thickness direction of the daylighting member; and
the ventilation hole comprises the first through hole.

4. The daylighting device according to claim 3, further comprising a light-diffusion member provided on either a light-entering side or a light-exiting side of the daylighting member, wherein:
the ventilation hole comprises the first through hole and a second through hole extending through a thickness direction of the light-diffusion member; and
the second through hole at least partially overlaps the first through hole when viewed normal to the daylighting member.

5. The daylighting device according to claim 4, wherein:
the light-diffusion member is provided on the light-exiting side of the daylighting member; and
the second through hole is smaller in size than the first through hole.

6. The daylighting device according to claim 4, wherein:
the second through hole has such a shape that has a lengthwise direction; and
the second through hole resides so that the lengthwise direction thereof is parallel to an extension direction of the daylighting sections.

7. The daylighting device according to claim 4, wherein:
the light-diffusion member comprises an adhesive layer having such anisotropy in light-diffusion properties as to diffuse more light in a direction that intersects the two disposition directions than in the two disposition directions; and
the daylighting member is provided on a transparent base member with the light-diffusion member interposed therebetween.

8. The daylighting device according to claim 4, wherein the ventilation hole forms a single communication hole by comprising the daylighting member, the light-diffusion member, and an affixing member provided between the daylighting member and the light-diffusion member disposed at a distance from each other.

9. The daylighting device according to claim 1, wherein the ventilation hole is provided in a region through which not much sunlight enters the daylighting member.

10. The daylighting device according to claim 1, wherein the ventilation hole has an inner face on which there is provided a material having light-blocking properties.

11. The daylighting device according to claim 1, further comprising a frame containing at least the daylighting member, wherein the ventilation hole is provided between the daylighting member and the frame.

12. The daylighting device according to claim 1, further comprising a frame containing at least the daylighting member, wherein the frame has at least two openings, one containing the daylighting member and the other serving as the ventilation hole.

13. The daylighting device according to claim 1, further comprising an exhaust fan in the ventilation hole, the exhaust fan being configured to vent air via the ventilation hole from a light-entering side to a light-exiting side.
